(19) United States
(12) Patent Application Publication
(10) Pub. No.: US 2025/0023081 A1
(43) Pub. Date: Jan. 16, 2025

(54) BIPOLAR ELECTRODIALYSIS BASED FLOW BATTERY SYSTEM

(71) Applicant: AQUA-CELL ENERGY INC., Calgary (CA)

(72) Inventor: Keith CLELAND, Calgary (CA)

(21) Appl. No.: 18/713,453

(22) PCT Filed: Nov. 25, 2022
(86) PCT No.: PCT/IB2022/061441

§ 371 Date: May 24, 2024

Related U.S. Application Data
(60) Provisional application No. 63/357,341, filed on Jun. 30, 2022.
(60) Provisional application No. 63/283,251, filed on Nov. 25, 2021.

(51) Int. Cl. H01M 8/22; B01D 15/36; B01D 61/46; H01M 8/04029; H01M 8/06; H01M 8/1053; H01M 8/18; H01M 8/241; H01M 8/2455

(52) U.S. Cl. CPC H01M 8/227; B01D 15/361; B01D 61/461; H01M 8/04029; H01M 8/0693; H01M 8/1053; H01M 8/184; H01M 8/241; H01M 8/2455

(57) ABSTRACT

A bipolar electrodialysis based flow battery system. Diffusion inhibiting solvents capable of operating at low temperatures are used in conjunction with permeable bipolar membranes that may operate in forward and reverse operation. An ion exchange column is utilized to regenerate stream compositions after operation with non-ideal membranes.

### CROSS-REFERENCE TO RELATED APPLICATIONS

This application claims priority to and the benefit of U.S. provisional patent application Nos. 63/283,251 (filed Nov. 25, 2021) and 63/357,341 (filed Jun. 30, 2022), which are incorporated herein by reference.

### FIELD OF THE INVENTION

The present invention relates to bipolar membranes and electrochemical cells that use electrodialysis processes to store energy.

### BACKGROUND OF THE INVENTION

Bipolar electrodialysis, the chemical splitting of solvent molecules, creating ions, may be achieved by using energy to apply a voltage potential to an electrochemical cell. The cell is composed of ion exchange membranes and flow channels, assembled to allow for chemical solutions to flow while membranes split solvent molecules and control the concentration of ionic species in the flow channels. When electricity/energy is applied the process is called forward bipolar electrodialysis (FBPED). The reverse process, combining ions in an electrochemical cell of the same design, is called reverse bipolar electrodialysis (RBPED). Reverse bipolar electrodialysis may be used to generate electricity.

Stationary energy storage is incredibly important for enabling renewable energy technologies. It should be robust and able to operate in a wide range of climates. Traditional BPED systems use water as the solvent. This isn't suitable in cold climates however, as the water-based chemistry will freeze. Flow batteries may be designed to use FBPED and RBPED to store electricity in the form of chemical energy. lon contamination, e.g., the diffusion of cations across an anion exchange membrane during operation, lowers the effective concentration of flow streams within the cell and is a major source of efficiency losses. The electrical/ionic resistance due to diffusion of ions in solution and across membranes when operating these flow batteries is another major source of efficiency losses.

During RBPED the accumulation of solvent at the junction where anion exchange membranes (AEM) and cation exchange membranes (CEM) meet (forming the bipolar membrane) may cause the membrane to delaminate and burst, rendering the flow battery useless. Solving the problem of solvent accumulation and membrane delamination is critical, and should be done while maintaining ionic conductivity and selectivity throughout the bipolar membrane. A published study (W. J van Egmond, 2018, Performance of an environmentally benign acid base flow battery, Wiley) has operated RBPED at low currents to avoid solvent accumulation, but at such low currents, the ion contamination effect becomes dominant and the energy efficiency was reported to be around 30%, which is much too low for energy storage applications.

### SUMMARY

According to various aspects, the present invention provides a system that includes multi-functional solvents, a treatment system and bipolar membranes, for converting chemical energy to and from electricity.

According to an aspect of the present invention, there is provided a solvent that may perform any or all of the following or may have any of the following properties. The solvent has a freezing point temperature below zero degrees Celsius. The diffusion of acid and/or conjugate base through the solvent is reduced with respect to their diffusion through water. The solvent may dissociate into an anion and a cation which could be acidic and/or basic within the bipolar membrane. The solvent may be a mixture of solvents with the above properties, and it may or may not be mixed with water, and/or solutes. The solvent may be fully miscible, partially miscible or not miscible with water and/or other solvents. An example of a solvent that has some the above properties is methanol. Characteristics of solvents that exhibit some of or all of the previously listed properties may include solvents without hydrogen bonding, solvents that have a hydroxyl group, alcohols, conjugate acid/base pairs, organic solvents, among others. Different streams within the electrochemical cell may contain different solvents. For example, a preferred embodiment could have solvent mixture that hinders acid or base diffusion in the acid/base streams with a different solvent mixture in the salt stream having different diffusion coefficients.

By using solvents that operate below 0 degrees Celsius, the BPED flow battery, or flow batteries in general may be used to store energy in cold climates. Solvents that reduce the diffusion of acid and/or base may improve the efficiency by reducing the undesired crossover of acid (such as hydrogen ions, i.e., H⁺ ions) or base (such as hydroxide ions, i.e., OH⁻ ions) across the ion exchange membranes (IEMs). Water is traditionally used in BPED processes as the solvent that may split into acidic cation/basic anions, but using other solvents with desired properties that may also split may be advantageous in storing chemical energy in the form of the additional split solvent. Typical ion exchange membranes are designed to be used with water. Using a mixture of water and other solvents takes advantage of well established water splitting mechanisms and membrane design while providing the benefits of the other solvents. Methanol is an example of a solvent that may be used in such a manner. Methanol is easy to synthesize or obtain, has a low freezing point, and may react at the BPM to form an acidic cation and basic anion. Cell designs that have different streams with different solvent mixtures allow various mechanisms to be targeted in the specific streams, such as reducing acid/base diffusion in the acid/base streams.

According to an aspect of the present invention, there is provided a catalyst that aids in splitting the non-water solvents. This catalyst may split water and/or non-water solvents. The catalyst may be aluminum or iron based, among others. The catalyst may be incorporated within or on the surface of the ion exchange polymer.

Catalysts improve the kinetics of the solvent splitting and may enable solvent splitting. This is especially important as the temperature decreases, as kinetics are slower at lower temperatures. Having a catalyst that splits water and other solvents may improve the effectiveness of solvent splitting. Aluminum and iron are known to split water, they could also be utilized to split other solvents. Splitting solvents that serve other functions such as reducing operating temperature may increase the total stored energy.

According to an aspect of the present invention, there is provided a solvent permeation layer (SPL) that allows solvent to flow in between layers of the BPM. In preferred embodiments the solvent permeation layer has ion conduction through ion exchange material and solvent flow around the ion exchange material. Catalyst may be applied in the solvent permeation layer to promote solvent splitting. A binder may be used in the SPL that may or may not conduct ions. The ion conductivity in the BPM may be increased though the use of ion exchange materials at the junction of the layers of the BPM. A binder material, with or without ion conductivity, may be incorporated into the structure of the BPM and SPL. The SPL may be connected to an external reservoir where solvent may flow to and from. The external reservoir may be used to control the composition and concentration of the SPL. The SPL may be patterned to direct solvent flow.

Having a BPM with solvent permeability/flow is important to mitigate the potentially damaging accumulation of solvent in the BPM. As solvent is generated within the BPM during reverse operation the pressure may increase within the BPM. By including a SPL within the BPM the pressure generated will drive solvent flow through the SPL, reducing the occurrence of delamination and other mechanical failures within the BPM. Using ion exchange material in the SPL may increase the ionic conductivity of the BPM, reducing the electrical resistance compared to the case where a layer of solvent has accumulated. The use of ion exchange material and/or catalyst in the SPL allows for operation of FBPED in addition to RBPED by facilitating solvent splitting. The binder material may be used to keep ion exchange material and/or catalyst and/or the anion exchange layer/cation exchange layer (AEL/CEL) together, improving mechanical stability. Having an ion conductive binder may improve the ionic conductivity of the SPL compared to non-conductive binder. Having an external reservoir connected to the SPL allows for the collection of solvent generated and prevents accumulation of solvent in the BPM. Using the reservoir to control the composition and concentration of the SPL may be useful for mitigating crossover diffusion processes of the acid and/or base ions. Having a patterned SPL allows for the solvent flow to be directed anywhere within the BPM, such as to an external manifold/reservoir or to a permeable section of the AEL/CEL where the solvent could flow through the AEL/CEL.

According to an aspect of the present invention, there is provided a solvent permeation layer that incorporates ion exchange resin. High contact between resin particles allows sufficient ion conduction for FBPED and/or RBPED processes. Solvent generated in RBPED may flow around the resin particles. Catalyst may be applied for improved solvent splitting. Pairing catalyst with the high surface area contact of anion exchange material and cation exchange material with the resin may enhance kinetics of the solvent splitting reaction, while maintaining solvent permeability. A size distribution for the resin could be used to further enhance the high surface area contact of anion exchange polymer and cation exchange polymer, while maintaining desirable permeability characteristics. In some embodiments smaller resin particles where the solvent splitting takes place interface with larger resin particles that allow solvent flow. In some embodiments the resin could be in contact with the AEL/CEL to form the solvent splitting interface. The resin could also be patterned in between the AEL and CEL to control solvent flow.

Ion exchange resin provides high surface area contact so that anion exchange polymer and cation exchange polymer may have a high surface area contact for solvent to split during FBPED. The resin may improve the conductivity of the BPM, reducing the ohmic resistance. The void between the resin particles allows solvent to flow which may help prevent delamination of the BPM. Having smaller resin particles increases surface area of the interface between anion and cation resin while having larger particles increases the solvent permeability between resin particles. A combination of large and small resin may allow for the benefits of both. Having a contact between resin and the AEL and/or CEL could be useful for simplifying design by only having one type of resin (anion or cation), by making the interface for splitting between the AEL/CEL and the CER/AER, while still having resin for solvent to flow.

Having patterns in the resin may allow for solvent flow to be directed anywhere, including out of the BPM, or to an external manifold or reservoir.

According to an aspect of the present invention, there is provided a permeable bipolar membrane. The AEL and/or CEL of the BPM may have permeability such that solvent may flow in the through-plane direction to the membrane interface. Upon solvent generation in the BPM the solvent may flow out of the membrane through the AEL and/or CEL. Holes, cracks, or perforations of any kind, in addition to inherently permeable membrane structures could be used to obtain the permeability in the AEL/CEL. The membrane structure may also change permeability under different process conditions. In some embodiments, the AEL and/or CEL will swell and/or change shape under the presence of different concentrations of solute and/or different compositions of solvent. The AEL/CEL could have a patterned permeable structure to promote solvent flow in a desirable way. The AEL/CEL could have a tapered/gradient design to change the permeability down the length of the membrane.

A permeable membrane enabling through plane flow allows for solvent generated in the BPM to flow to the flow away from the membrane interface to flow channels, reducing the occurrence of BPM delamination. Permeability may be obtained through a variety of forms which allow solvent to flow out of the AEL and/or CEL. By altering permeability under different conditions, some embodiments could be designed so that the membrane is less permeable (and therefore more selective) for FBPED operation, and/or more permeable for RBPED operation. Changes in the concentration and composition of streams between the FBPED and RBPED cycles may be taken advantage of to change the permeability of the AEL and/or CEL. In some embodiments, during RBPED, high concentration solutions at the inlet could cause a more permeable membrane structure and a path for solvent to flow out of. A pattern in the AEL/CEL structure could promote flow of solvent toward the inlet where it may escape. In an embodiment combining a permeable membrane with a patterned SPL, the flow could be directed to the more permeable regions of the AEL and/or CEL so the solvent may flow out of the membrane.

According to an aspect of the present invention, there is provided heat exchanging with the According to an aspect of the present invention, there is provided an ion exchange column that may be used to regenerate streams to a desired concentration/composition. If operating with membranes that aren't perfectly selective, the contaminated stream may flow through a column containing ion exchange material to obtain a preferred ionic concentration/composition of the stream. In some embodiments the ion exchange material is ion exchange resin. The solvent may also be regenerated by reacting acid and/or base in the stream with the ion exchange material containing the conjugate acid/base. The ion exchange column may operate in a batch mode after several cycles of flow battery operation, or in continuous mode at the same time as the flow battery operation.

The ion exchange column may change the concentrations of any stream in the BPED system by exchanging ions from the ion exchange material to the stream. This is advantageous as it offers a solution to contamination processes that occur from operating flow batteries (BPED flow batteries included). Less interference in the process is required, and the ion exchange polymer could be replaced at a much lower frequency than would be required if the solution were to be changed. Solvent regeneration is beneficial as the solvent ratios may change over the course of BPED operation if a multicomponent solvent mixture is being used. In some embodiments, resin loaded with conjugate acid or base of the solvent may be used to add solvent to the stream at the same time as removing acidic or basic contaminations.

Other features and advantages of the present invention are described more fully below.

### BRIEF DESCRIPTION OF THE DRAWINGS

The drawings are not to scale and various features are exaggerated to aid explanation.

FIG. 1 is a diagram of a BPED flow battery system with a single unit cell that has connections to a contamination treatment system according to an embodiment of the invention.

FIGS. 2 and 3 is a diagram of a BPED flow battery with a single unit cell that is generalized. Membranes and flow channels are arranged together in the following order: salt compartment, AEM, acid compartment, BPM (with CEL in fluid communication with acid compartment), base compartment (with AEL in fluid communication with base compartment), CEM, which is a cell triplet pattern that may be repeated to form a stack of cells. The cell triplet is a unit cell that the reverse and forward BPED process occurs within. NaCl, HCl, NaOH are depicted in the streams and in various implementations any suitable salt, acid, base or solvent may be used.

FIG. 4 is a diagram of a stack of cell triplets in between the electrode systems, and an external circuit to which the electrodes may connect. Three triplets are depicted but any suitable number may be stacked.

FIG. 5 is a diagram of an example of a permeable bipolar membrane with permeable layers according to an embodiment of the invention. In this embodiment the AEL. is permeable. In other embodiments the CEL may be permeable, and the AEL may not be permeable.

FIG. 6 is a diagram of a once through method of operating the BPED system that works in conjunction with permeable bipolar membranes according to an embodiment of the invention.

FIGS. 7-11 are close-up diagrams of BPM showing various solvent permeation layer configurations according to embodiments of the invention. The invention is not limited to what is depicted in the figures, as any permutation of AER, CER, MBR at any resin size particles are possible. The dotted background of components resembles catalyzed ion exchange polymer, and any permutation of any ion exchange material within the permeable BPM/SPL with or without catalyst is possible. More or less filling of void space than depicted is possible.

FIG. 12 is a diagram of a permeable BPM with ion exchange resin, permeable layers and catalyst according to an embodiment of the invention.

FIG. 13 is a diagram of a configuration that shows general BPED operation in a looping mode, and includes streams to the regeneration IEC according to an embodiment of the invention.

FIG. 14 is a diagram of the ion exchange column for BPED streams to flow through and change their composition/concentration according to an embodiment of the invention.

FIG. 15 is a diagram of an ion exchange process on ion exchange polymer such as ion exchange resin.

FIG. 16 is a diagram of a preferred embodiment of regenerating a salt-contaminated acid stream with ED.

FIG. 17 is a diagram of a preferred embodiment of regenerating a salt-contaminated base stream with ED.

FIG. 18 is a diagram of a preferred embodiment of regenerating a base-contaminated salt stream with ED.

FIG. 19 is a diagram of a preferred embodiment of regenerating an acid-contaminated salt stream with ED.

### DETAILED DESCRIPTION

Bipolar electrodialysis is a technology that is traditionally used for simultaneous production of acids and bases. Electricity is applied to a stack of ion exchange membranes, and a chemical process occurs where saline water undergoes a dissociation reaction to produce acid and base simultaneously. This process may be reversed, however there are challenges associated with reverse operation. The current bipolar membrane technology was designed for forward operation, it does not operate effectively in reverse. An important issue is water accumulation in between the anion exchange layer (AEL) and the cation exchange layer (CEL) of the membrane.

Water and/or other solvents are split at the interface of the AEL and cation exchange layer CEL, (i.e., the bipolar membrane interface), by an extremely strong electric field which exists at the interface of the BPM. This extremely strong electric field gradient arises when electroneutrality is no longer present at the BPM interface. The main electric field generated by the electrodes causes anions to move through the AEL, and cations to move through the CEL, in opposite directions from each other, causing local non-electroneutrality at the BPM interface. This generates a local voltage gradient (reference Poisson's equation). This sharp voltage gradient, localized in a nanometer scale region at the membrane interface, is strong enough to split the solvent molecule into a cation and an anion. In splitting water at the bipolar membrane interface, a proton, H⁺, and a hydroxyl ion, OH⁻ are generated from the water (H₂O). A catalyst may be used to aid in the water splitting. H⁺ migrates through the CEL to the acid stream, and OH⁻ migrates through the AEL to the base stream. At the same time, ions such as sodium and chloride migrate across the CEM and AEM adjacent to the base and acid streams to combine with the H⁺ and OH⁻, forming hydrochloric acid and sodium hydroxide. This combination of AEM, CEM, and BPM, with an acid, base, and salt stearn in between makes up a cell triplet. This triplet may then be repeated in a stack in series. At the ends of the stack an electrode channel is present where an electrochemical reaction takes place to convert the ionic current generated in the cell triplets to electric current.

The stored chemical energy in the form of an acidic and basic solution may then be converted back into electricity by running the bipolar electrodialysis process in reverse. The acid and base streams flow in their respective channels. H⁺ and OH⁻ migrate across the CEL and AEL and recombine to form H₂O at the BPM interface. The chloride ions, Cl, from the HCl migrate across the AEM to the salt solution and sodium ions, Na⁺, move from the base, across the CEM to the salt. The electrode reactions run in reverse, generating electric current.

Forward bipolar electrodialysis (FBPED) has been commercially available for the last 30 to 40 years. Reverse bipolar electrodialysis (RBPED) however, has not been a feasible technology until recently. A patent in the 1980s patented the process of running RBPED, however at the time the ion exchange membranes (IEMs) were immature and not ready for commercial development. Early generation IEMs had poor permselectivity, the membrane's ability to block co-ions over counter ions (e.g., For a cation exchange membrane to block anions). As electrodialysis (ED) and BPED technology have evolved, so have the membrane properties. Now with membranes exceeding 90% permselectivity, the efficiency of BPED flow battery technology is becoming high enough to make RBPED feasible.

There are still problems to overcome with BPED flow batteries. During reverse operation, H⁺ and OH⁻ combine at the interface of the AEL and CEL, forming water in the middle of the BPM. If the process is run at a high current, a large amount of water will form in the center of the BPM. BPMs used in FBPED may be created by pressing or fusing the AEL and CEL together, maximizing the contact between them. However, when the process is run in reverse at a high current density, water generated at the membrane junction does not diffuse though the AEL and CEL fast enough. As water accumulates in the membrane the AEL and CEL delaminate, causing destruction of the BPM. This phenomenon has been observed in recent studies. This layer of water generated at the center of the membrane also reduces the ionic conductivity.

The RBPED process could be operated at a lower current density to prevent delamination, but this is not ideal. In general, for energy storage devices it is preferred to operate at high currents, which lead to high power. A fundamental problem with the technology is the high diffusion rates of H⁺ and OH⁻. At low current density, less ions migrate across the membranes due to a smaller electric field. With a smaller ion flux, back diffusion processes become significant; it is easier to diffuse against a weaker electric field. H⁺ for example may diffuse across the anion exchange membrane that it is adjacent to and cause contamination of the salt stream of the cell, making the salt stream more acidic. A published study demonstrated about 30% efficiency for BPED flow batteries while operating at low current densities but it is predicted the efficiency may be much higher at a higher current density.

Solution chemistry designed to reduce the diffusivity of acid and base ions reduces this effect. Reformation of product streams outside of the electrochemical cell may be used to adjust ion concentrations prior to RBPED operation, improving electrical efficiency.

Promoting solvent flow in both the in-plane direction, and though the layers composing the bipolar membrane is effective in limiting membrane failure.

Increasing the permselectivity of the membrane and promoting the movement of solvent molecules out of the bipolar membrane, by diffusive or convective mechanisms is critical for solving solvent accumulation Improving the mobility of ions within the flow channels and through the membranes in the flow battery increases the electrical efficiency of the battery.

This description provides improvements to the BPED process by operating at a higher power and efficiency, lower temperature as well as ways to mitigate contamination. The process uses solvents that are in liquid form for temperatures above and below 0 degrees Celsius. During FBPED, the solvents are split in the bipolar membrane using high surface area ion exchange polymer that may be catalyzed. During RBPED the solvent generated in the bipolar membrane has somewhere to flow to prevent accumulation of solvent in the bipolar membrane. The bipolar membrane has different forms under different process conditions, with a preferred embodiment having more permeability in RBPED operation than in FBPED. The solutions used in the BPED processes that have changed concentration through operation with imperfect selectivities may be reconstituted/regenerated by exchanging ions with ion exchange polymer, such as in an ion column.

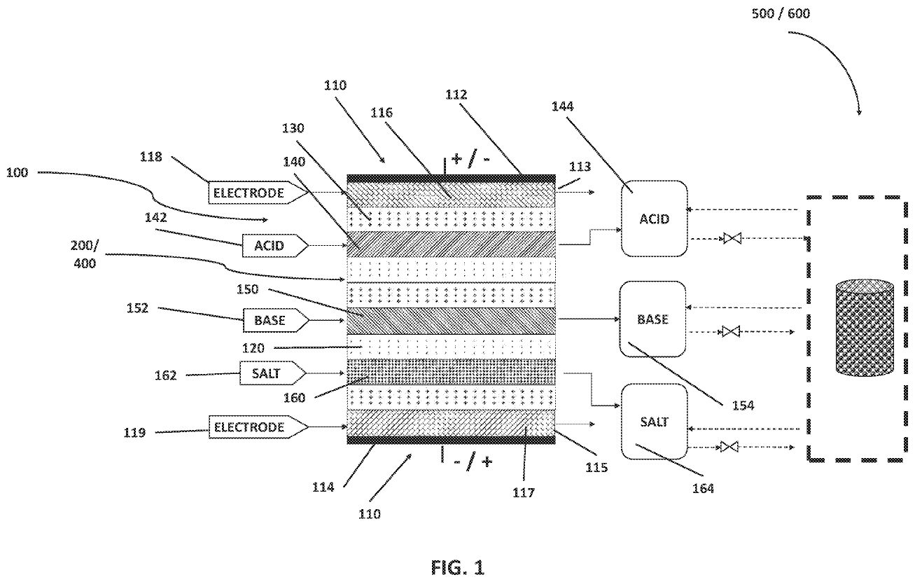

FIG. 1 shows the overall BPED process, with a BPED stack indicated generally at 100. An ion exchange column is indicated generally at 500. A bipolar membrane (BPM) is indicated generally at 200. The BPED stack 100 includes an electrode system 110, and a cell triplet containing a cation exchange membrane (CEM) 120, anion exchange membrane (AEM) 130, BPM 200/400, acid flow channel 142, base flow channel 152, and a salt flow channel 162. The BPED stack 100 is a device that may convert electrical to chemical energy. The ion exchange column 500 is a device that changes the concentration/composition of the streams. The electrode system 110 converts ionic current into electrical current. The CEM 120 allows transfer of cations between adjacent streams. The AEM 130 allows transfer of anions between adjacent streams. The BPM 200/400 allows splitting and/or recombination of solvent molecule into/from cations and anions. The BPED stack may contain one or several cell triplets stacked, wound and/or arranged in series. The acid stream 140 flows through the acid flow channel 142. During forward bipolar electrodialysis (FBPED) operation the acid stream 140 becomes more acidic, and less acidic for reverse bipolar electrodialysis (RBPED) operation. The base stream, 150 flows through the base flow channel 152, becoming more basic for FBPED operation and less basic for RBPED operation. The salt stream, 160 flows through the salt flow channel 162 and becomes more dilute for FBPED operation and more concentrated for RBPED operation. The acid stream 140, base steam 150 and salt stream 160 may be stored in tanks 144, 154, and 164 respectively. Additional tanks may also be used at the inlet (not shown in FIG. 1). Streams leading to and from the ion exchange column

### Electrode/Electrode Stream

The electrode system 110 is now described in greater detail. Electrodes 112 and 114 may be placed at either end of the stack of cell triplets. The electrode is at the end of the stack, and in between the electrode and the stack of cells may be a flow channel 116 and 117, for the electrode stream(s) 118 and 119. The same stream may flow through/by both electrodes in series and/or parallel, or there may be separate streams as depicted. It may be made of any metal, carbon or any material that conducts electrons.

The main function of the electrode system 110 is to convert ionic current (ions flowing through the membranes and flow streams) into electric current (electrons moving through a wire) and vice versa. This may be done with a Faradaic or non-Faradaic process, that is, with or without an electrochemical reaction at the electrode. If there is a reaction, the redox couple at the electrodes or electrochemical reactions used is arbitrary, as the main mechanism for energy storage in BPED is via solvent splitting at the membranes. For example, if a CEM separates the electrode stream and the cell triplets, a cation will leave/enter the electrode stream and an electrochemical reaction will take place that results in either an oxidation or reduction of a component in the electrode stream, causing electrons to flow through the external circuit. In the case of a non-Faradaic process, the electrode may behave like a capacitor, and when ions enter/leave the electrode stream they adsorb onto the electrode and the accumulation (or vice versa) of charge in the electrode will cause electrons to flow through the external circuit. Stacks may be connected electrically in series or parallel to achieve any power output via varying voltage/current density. AEM or CEM or other separators could separate the electrode stream.

### Cell Triplet

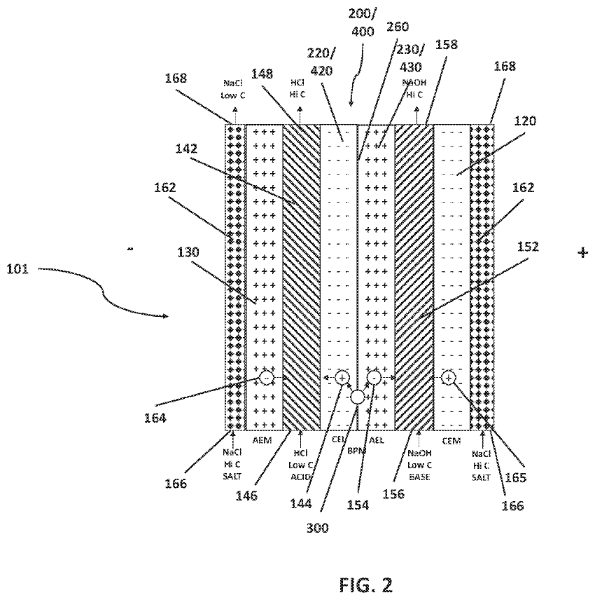

FIG. 2 shows a cell triplet 101. Components and operation of the cell triplet are now described in more detail. In this figure, example solutes and solvents are used as HCl, NaOH, NaCl and H₂O. In other examples, any suitable salt, acid, base may be used as well as any solvent, such as methanol, glycol, or others. The cell triplet includes an CEM 120, AEM 130, BPM 200 or permeable BPM 400, acid compartment 142, base compartment 152, salt compartment 162, solvent 300 and anions 154/164 and cations 144/165. The acid, base, and salt compartments 142, 152, 162 are to contain respective acid, base, and salt solutions.

The ion exchange membrane (IEM) is a membrane that may be made of a polymer that is conductive to ions. The membrane has a porous structure where the pores are filled with a solvent that may be pure water or water with another solvent or another solvent. Depending on the application, the solvent may have ions dissolved in it. The polymer has functional groups in the polymer structure. These functional groups may have either a positive or negative charge. For a membrane with a positive ‘fixed charge’ in the polymer structure, there should be a negative ‘counter-ion’ adsorbed to the positive charge in the polymer structure. Similarly, for a membrane with a negative fixed charge, there should be a positive ‘counter-ion’ adsorbed to the negative fixed charge. These counter-ions are free to move through the membrane structure, unlike the fixed charges. Under the influence of an electric field the counter-ions will flow through the membrane, provided there is electroneutrality between the membrane fixed charge, and the counter-ions. Electroneutrality may be broken under a strong enough electric field, and if this happens, phenomena such as water splitting may occur

### Anion Exchange Membrane (AEM)

The anion exchange membrane (AEM) 130 is membrane where fixed charge is from positive ions. lons, predominantly anions, migrate through the membrane under an electric field. If the permselectivity of the membrane is not equal to 1 (the ideal value for a membrane with perfect selectivity to anions), cations may also cross the membrane.

### Cation Exchange Membrane (CEM)

The cation exchange membrane is a membrane where fixed charge is from negative ions. Primarily cations will migrate through the membrane under an electric field. If the permselectivity of the membrane is not equal to 1 (the ideal value for a membrane with perfect selectivity to cations), anions may also cross the membrane.

### Bipolar Membrane (BPM)

The bipolar membrane (BPM) 200 is a membrane that includes two membrane layers that are in contact with each other. These are an anion exchange layer (AEL) 230, and a cation exchange layer (CEL.) 220, which are similar to the AEM 130 and CEM 120. A BPM 200 may have material in between the AEL 230 and CEL 220. Catalyst 264 may be applied anywhere throughout the BPM to enhance the splitting of the solvent 300, most commonly at the BPM interface 260 (discussed below).

Under an electric field, a solvent molecule 300 (i.e., water or other solvent), splits into a cation 144 and anion 154 (H⁺ and OH⁻ in the case of H₂O). These cations 144 and anions 154 then migrate through the CEL 230 and AEL 220, respectively, driven by the electric field. The solvent 300 may be split by a dissociation reaction at the BPM interface 260 (defined below). Upon application of an electric field, counterions will be depleted in the AEL 230 and CEL 220, and at the BPM interface 260, an imbalance in charge occurs, where electroneutrality is not maintained. This loss of electroneutrality results in an extremely high voltage gradient, causing the solvent 300 to split into an anion 154 and a cation 144, which may be an acid and a conjugate base pair.

### BPM Interface

The BPM interface 260 is the region where anion exchange polymer meets cation exchange polymer, which may be at the center of the BPM. For example, in simple BPMs 200 containing just a CEL 220 and AEL 230, the interface is where the AEL and CEL make contact. Another example is BPMs with resin incorporated; the interface may be where the cation/anion resin meets the AEL/CEL, or the anion/cation resin. The BPM interface 260 is where the solvent splitting reaction takes place. The interface may be a matrix where anion exchange material and cation exchange material meet

During FBPED, the main function of the interface is to split the solvent molecule into an anion and a cation. From the interface 260 (in between the AEL and CEL), the anions and cations generated migrate (move under presence of electric field) through the AEL 230/430 and CEL 220/420, respectively, away from the BPM interface 260 towards the flow channels 142 and 152. The BPM interface 260 may have a catalyst 264 present to facilitate the solvent splitting reaction and/or very high surface area of cation exchange polymer in contact with a very high surface area of anion exchange polymer.

During RBPED, the solvent is formed at the BPM interface. Anions from the AEL 230/430 and cations from the CEL 230/430 migrate from the flow channels 142 and 152 to the BPM interface 260 and combine to form solvent 300. In traditional designs for FBPED, the BPM interface 260 is formed from just an AEM/AEL 130/230 and a CEM/CEL 120/220, that is, just two membranes joined together. This design is not ideal for RBPED because the solvent accumulates in between the two membrane layers. It will accumulate and cause a pressure driven flow through the AEL 230/CEL 220 to the flow channels. At high current densities (and therefore high rate of solvent generation), if the membranes are not sufficiently permeable to the solvent, the pressure increases and the AEL 230 and CEL 220 may delaminate from each other. To prevent this phenomenon, when operating RBPED at higher power outputs/current densities, solvent flow from the BPM Interface 260 may be enabled to prevent solvent accumulation. This should be done in such a way that the interface 260 between anion exchange polymer and cation exchange polymer and/or the catalyst 264 is not compromised for FBPED operation. This is elaborated upon below in the discussion of the solvent permeation layer section and permeable AEL/CEL section.

### Acid Stream/Compartment

The acid stream 140 normally contains a solvent with an acid dissolved in it. The acid stream 140 may also have other salts/ions dissolved. One side of the acid compartment 142 has fluid contact with an AEM 130, and the opposite side is in contact with the CEL 220 of the BPM 200. Any type of dissolved acid or ions may be used, with any type of solvent in the acid stream.

During FBPED, an electric field is applied. In FBPED, the solvent splits at the BPM 200/400, and the acidic cation 144 (H⁺ if the solvent is H₂O), migrates from inside the BPM 200/400, through the CEL 220/420 into the solution flowing through the acid compartment 142, i.e., the acid stream 140. The same electric field causes anions 164 (chloride ions, i.e., Cl ions, if NaCl is the salt dissolved in the salt stream) to migrate from the salt stream 160, across the AEM 130, to the acid stream 140. For example, if the solvent is H₂O and the salt used is NaCl, the H⁺ from the CEL 220/420 and the Cl from the AEM 130 form HCl in the acid stream. From the inlet of the acid compartment 146 to the outlet of the acid compartment 148, the acid stream 140 becomes more acidic during FBPED.

During RBPED, the reverse process happens. An acidic solution enters the inlet of the acid compartment, 146. The electric field may be generated in RBPED from spontaneous ion flow, opposite of the direction of the electric field applied in FBPED. The acidic cation 144 (H⁺ if the solvent is H₂O), migrates from the acid stream 140, through the CEL 220/420, to the BPM interface 260. Here, the acidic cation 144 reacts with a basic anion that migrated from the base stream 150 through the AEL 230/430 to the BPM interface 260 (this basic anion could be OH if it was split from an H₂O solvent). The acidic cation 144 and basic anion 154 react and combine at the BPM interface 260. The same electric field causes anions 164 (Cl if NaCl is the salt dissolved in the salt stream) to migrate from the acid stream 140, across the AEM 130, to the salt stream 160. For example, if the solvent is H₂O and the acid used is HCl, the H⁺ leaves the acid stream 140 through the CEL 220 and the Cl leaves the acid stream 140 through the AEM 130. From the inlet of the acid compartment 146 to the outlet of the acid compartment 148, the acid stream 140 becomes less acidic during RBPED.

### Base Stream

The base stream 150 normally contains a solvent 300 with a base dissolved in it. The base stream 150 may also have other salts/ions dissolved. One side of the base compartment 152 has fluid contact with a CEM 120, and the opposite side is in contact with the AEL 230/430 of the BPM 200/400. Any type of dissolved base or ions could be used, with any type of solvent in the base stream 150.

During FBPED, an electric field is applied. In FBPED, the solvent splits at the BPM 200/400, and the basic anion 154 (OH⁻ if the solvent is H₂O) migrates from the BPM interface 260 through the AEL 230/430 into the solution flowing through the base compartment 152, that is, the base stream 150. The same electric field causes cations 165 (Na⁺ if NaCl is the salt dissolved in the Salt stream) to migrate from the salt stream 160, across the CEM 120, to the base Stream 150. For example, if the solvent is H₂O and the salt used is NaCl, the OH⁻ from the AEL 230/430 and the Nat from the CEM 120 form NaOH in the base stream 150. From the inlet of the base compartment 156 to the outlet of the base compartment 158, the base stream 150 becomes more basic during FBPED.

During RBPED, the reverse process happens. A basic solution enters the inlet of the base compartment 156. The electric field may be generated from spontaneous ion flow in the opposite direction as FBPED. The basic anion 154 (OH⁻ if the solvent is H₂O) migrates from the base stream 150 through the AEL 230/430 to the BPM interface 260. Here, the basic anion 154 reacts with an acidic cation 144 that migrated from the acid stream 140 through the CEL 220/420 to the BPM interface 260 (this acidic cation could be H⁺ if it was split from an H₂O solvent). The acidic cation 144 and basic anion 154 react and combine at the BPM interface 260 (if H⁺ and OH⁻ react they form H₂O). The same electric field causes cations 165 (Na⁺ if NaCl is the salt dissolved in the salt stream) to migrate from the base stream 150 across the CEM 120, to the salt stream 160. For example, if the solvent is H₂O and the base used is NaOH, the OH⁻ leaves the base stream 150 through the AEL 230/430 and the Na⁺ leaves the base stream 150 through the CEM 120. From the inlet of the base compartment 156 to the outlet of the base compartment 158, the base stream 150 becomes less basic during RBPED.

### Salt Stream

The salt stream 160 normally contains a solvent 300 with a salt dissolved in it. The salt stream 160 may also have other acids, bases, and/or ions dissolved. One side of the salt compartment 162 has fluid contact with a CEM 120, and the opposite side is in contact with an AEM 130. Any type of dissolved acid or base or ions may be used, with any type of solvent in the salt stream.

During FBPED, an electric field is applied. The electric field causes cations 165 (Na⁺ if NaCl is the salt dissolved in the salt stream) to migrate from the salt stream 160 across the CEM 120 to the base stream 150. The same electric field causes anions 164 (Cl if NaCl is the salt dissolved in the salt stream) to migrate from the salt stream 160 across the AEM 130 to the acid stream 140. For example if the solvent is H₂O and the salt used is NaCl, Na⁺ from salt stream 160 migrates to the base stream 150 to form NaOH, and Cl from the salt stream 160 migrates to the acid stream 140 to form HCl. From the inlet of the salt compartment 166 to the outlet of the salt compartment 168, the salt stream 160 becomes less concentrated during FBPED.

During RBPED, the reverse process happens. During RBPED, an electric field is generated due to spontaneous ion flow in the opposite direction as in FBPED. The electric field causes cations 165 (Na⁺ if NaCl is the salt dissolved in the salt stream) to migrate from the base stream 150, across the CEM 120, to the salt stream 160. The same electric field causes anions 164 (Cl if NaCl is the salt dissolved in the salt stream) to migrate from the acid stream 140 across the AEM 130 to the salt stream 160. From the inlet of the salt compartment 166 to the outlet of the salt compartment 168, the salt stream 160 becomes more concentrated during FBPED.

Note that in the acid, base, salt stream sections, the AEL 230 and/or CEL 220 may be replaced with the permeable AEL 430 and/or permeable CEL 420, as introduced later herein.

### BPED Stack

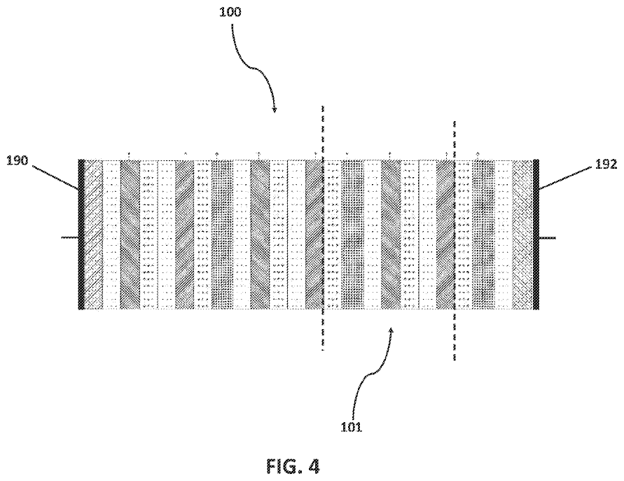

FIG. 4 shows a BPED stack 100 of cell triplets 101. The cell triplets 101 and components within each triplet 101 are electrically in series, so stacking triplets increases the voltage. Manifolds may be provided to the stack of triplets to flow the acid, base, salt, and electrode streams. The manifolds may direct flow to be parallel to the membranes and flow channels of the cell triplets 101. That is, the cell triplets 101 are in parallel with respect to flow. The inventions described pertain to both a single cell system, a stack of these cells and multiple stacks of these cells.

Electrodes 190, 192 located on either side of a cell triplet, or stack of cell triplets, allow for an electric potential to be applied across the unit cell during FBPED and serve to collect electric current generated during RBPED. Multiple cell triplets may be stacked in between the two electrode chambers for a larger system, as shown in FIG. 4. Three triplets are shown in the figure but in practice hundreds of triplets may be stacked If the electrode compartment is isolated with a CEM, the previous mentioned order beginning with the salt compartment is desired. If the electrode compartment is isolated with and AEM, the previous list may be used in the same order, but beginning with the acid compartment, and ending with the salt compartment. In theory, the stack of cells may begin or end with either of the acid, base or salt streams.

### Solvent

The purpose of the solvent for ED may to be a medium for dissolved ions to be transported. In BPED the solvent may also undergo a chemical reaction where it is split into an acid and its conjugate base. Solvents may include H₂O as well as other compounds as discussed herein. A solvent may be a solution of water and another material, pure water, or another material without water.

Methanol for example may be mixed into the electrolyte and take place in the reaction. One function of methanol is to interrupt the diffusion mechanism for H⁺ and OH⁻. H⁺ and/or OH⁻ ions diffuse by the Grotthuss mechanism and the addition of methanol could prevent percolation of water molecules, reducing the diffusion of H⁺ and/or OH⁻. If the diffusion coefficient of H⁺ and/or OH⁻ is significantly reduced, this makes much lower crossover, especially at lower current densities, and results in a significant improvement in efficiency.

The use of methanol also improves the temperature range that the BPED system may operate. Temperatures below freezing may be achieved by incorporating other solvents like methanol. For example, a 20% methanol 80% water mixture may remain liquid at temperatures below −20 degrees Celsius.

Other solvents may be used to achieve the same or similar effects. Solvents that reduce the freezing point temperature may be used. Any solvent with full or partial miscibility in water may be used. Likewise, to reduce the Grotthuss mechanism, another fluid mixed with water may be used to interrupt the Grotthuss diffusion mechanisms H⁺ and OH⁻ through the water. These solvents may be used with or without water as well. Preferably, the solvent used will have lower diffusion coefficients of H⁺ and/or OH⁻ (when compared to the diffusion of H⁺ and OH⁻ in H₂O), reduce the freezing point of the solvent mixture, and/or be split in the BPM. However, a suitable solvent may have one or more of those properties and then be mixed with another suitable solvent with the remaining properties. For a molecule to be split at the BPM interface, it should preferably have a hydroxyl group. It could also be a molecule with a conjugate acid or conjugate base. Solvents may interrupt the Grotthuss mechanism, through reduction in hydrogen bonding when compared to water, and/or through interruption in water percolation, among other mechanisms. For operation in cold climate, the solvent and/or mixture of solvents should have a freezing point below 0 degrees Celsius or a range of temperatures experienced in cold climate, including temperatures around −30° C. (or below −5° C./−10° C. if the external temperature is not too cold or the system is being heated).

The diffusion coefficient of the acidic cation and/or basic anion may also be reduced by operating at a lower system temperature. A low temperature could be applied to the acid and/or base stream to reduce the diffusion coefficients, which are dependent on temperature. This may be applied in conjunction with a solvent that reduces the freezing point temperature when compared to water, such as methanol, among others, further reduce the diffusion coefficient of the acidic cation and/or basic anion through operating at an even lower temperature to reduce the diffusion coefficient, and to interrupt the Grotthuss mechanism.

### Supporting Data

It was shown through simulation that the incorporation of a solvent reduces the flux of acidic cations and basic anions to the salt channel. The diffusion coefficient of H⁺ in water is 9.31*10⁻⁹ m²/s, while the diffusion coefficient of H⁺ in a 20% methanol in water solution is 6.06*10⁻⁹ m²/s. COMSOL was used to solve the Nernst Planck Poisson equations for the transport of H⁺ across the AEM that could be used in a BPED flow battery. It is undesirable for the acidic cation (H⁺ in this case) to cross the AEM adjacent to the acid stream, into the salt stream. It was shown that the flux of H⁺ was lower when the water-methanol solvent was used. The flux of H⁺ when a pure water solvent was simulated was 0.0020 mol/m²s, while the flux of H⁺ when a 20% methanol in water solvent was used was 0.0013 mol/m²s. The same principle may be applied to the OH⁻ diffusion. With a lower transport of unwanted H⁺ and OH⁻, the system will have a higher current efficiency, especially at a low current density where diffusive processes may account for a larger portion of the transport when compared to at a higher current density, where migration is dominant. Mixing any other solvent with water that reduces the diffusion coefficient of H⁺ and/or OH⁻ may also obtain a reduction in the H⁺ and/or OH⁻ flux, and therefore higher current efficiency.

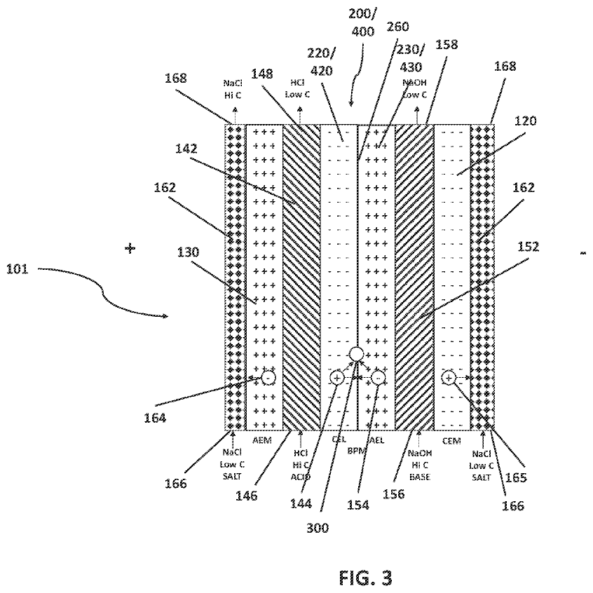

It was further experimentally confirmed that the current efficiency could increase by incorporating a solvent mixture that has properties mentioned herein into a BPED flow battery. A BPED flow battery was built (two cells, 100 cm² active area/cell) and was used for testing various solvent mixtures. The BPED flow battery was built consistent with the teachings herein (see FIGS. 2, 3, 4, and 6). It was built with two cell triplets 101, and was assembled in the following order: electrode 114, electrode compartment 115, CEM 120, base compartment 152, BPM 200 (i.e., AEL 230, CEL 220), acid compartment 142, AEM 130, salt compartment 162, CEM 120, base compartment 152, BPM 200 (i.e., AEL 230, CEL 220), acid compartment 142, AEM 130, salt compartment 162, CEM 120, electrode compartment 115, electrode 114. Two solid end blocks on either side of the electrode were fastened together to compress and seal the cell.

A BPED flow battery as described above was built used to test various solvent mixtures, including water, ethylene glycol and water, and methanol and water. The tests were completed at similar conditions, aside from the varied solvent. A similar cell was built and tested for each solvent with the acid, base and salt streams at the same concentration of approximately 0.5 M. Most current efficiency tests were performed at 20 ml/min/cell. The current efficiency was measured for both tests by comparing the concentration of H⁺ in the acid stream entering the BPED flow battery with the acid stream leaving the BPED flow battery, and comparing this charge moved to the current applied. The concentration of H⁺ was measured via titration with NaOH.

A solvent mixture was prepared at various ratios of ethylene glycol in water, including a 20% by volume ethylene glycol in water mixture. The acid, base and salt streams were prepared to be approximately a 0.5M mixture of HCl, NaOH, and NaCl, respectively, with the 20% ethylene glycol in water solvent. At an applied charging current of 3 A (300 A/m²), the current efficiency for the water/ethylene glycol mixture was 87%. This is higher than the current efficiency where water with no co-solvent is used, (i.e., in the case of a water-based solvent), (at approximately a 0.5 M mixture of HCl, NaOH, and NaCl, for acid, base and salt respectively), where the current efficiency was 70% with a current density of 300 A/m². A similar cell was built, and the current efficiency was measured for the discharge at −0.6 A (−60 A/m²). With a water-based solvent at approximately a 0.5 M mixture of HCl, NaOH, and NaCl, for acid, base and salt respectively, the current efficiency was measured to be 90% at −60 A/m². With a 10% ethylene glycol in water-based solvent at approximately a 0.5 M mixture of HCl, NaOH, and NaCl, for acid, base and salt respectively, the current efficiency was measured to be 93% at −60 A/m². The use of glycol also improves the heat transfer properties of the solutions. For example, an ethylene glycol and water mixture reduces the diffusion coefficient of ions dissolved in it when compared to the diffusion coefficient of water. The diffusion coefficient of Na⁺ in a 20% by volume ethylene glycol in water solution is 0.89*10⁻⁹ m²/s, as compared to 1.33*10⁻⁹ m²/s. A diffusion coefficient reduction is also expected for H⁺ and OH⁻ for mixtures of water and ethylene glycol or other solvents.

Another BPED flow battery was tested with a 40% by volume methanol in water solvent. Solutions of 0.5 M HCl, NaOH, NaCl for the acid, base, salt streams, respectively, were prepared using the methanol and water solvent and tested in the BPED flow battery. The current efficiency was measured in the same way as described above. The current efficiency for the methanol and water solvent was 80% at 300 A/m². This was higher than the current efficiency for the water only based solvent, where the current efficiency was 70% at 300 A/m².

These increases in the current efficiency may be from the reduction of diffusion coefficients and/or a change in the membrane's permselectivity from a change in the membrane structure due to the presence of a solvent, as elaborated upon in the discussion of BPM in this disclosure. These experimental observations support the teachings presented herein.

A solvent may be selected based on how the solvent interacts with the ion exchange membrane or how the solvent affects ion transport. As discussed, solvents that change membrane properties, such as the size and selectivity of the membranes, may improve BPED flow battery performance. This may be due to solvent interactions with the ion exchange polymer. One way to inform the choice of effective solvents may be to base solvent selection on properties of the solvent that may change how it interacts with the ion exchange polymer. An example of a property that may influence the solvent/ion exchange polymer interaction is the Dielectric Constant or permittivity of the solvent, as this may affect the electrical interaction at the molecular scale, which may influence properties of the ion exchange polymer such as the ones discussed in this document. For example, the dielectric constant of water is approximately 80 at 20 degrees Celsius, whereas the dielectric constant of a couple of the solvents that were added to water: methanol and ethylene glycol are approximately 33 and 37 respectively, at 20 degrees Celsius. It may be that solvents with a lower Dielectric Constant or permittivity than water are particularly useful in certain applications. It may also be that solvents that reduce the diffusion coefficient of acidic cation and/or basic anions may be particularly useful.

It has been found that using a solvent mixture that has a dielectric constant lower than that of water (i.e., the dielectric constant of the solvent mixture before mixing with ions), which has a dielectric constant of approximately 80, was effective at improving BPED flow battery performance, including but not limited to an increase in the current efficiency, an increase in the open circuit voltage, an increase in the power density. Having a dielectric constant in the range from 15 to 80 was also found to be effective. Having a dielectric constant in the range of 30 to 80 was also found to be effective. Having a dielectric constant in the range of 45 to 80 was also found to be effective. Having a dielectric constant in the range of 60 to 80 was found to be especially effective. As an example, as described herein, a BPED flow battery was tested with water/methanol and water/ethylene glycol solvent mixtures in which better performance related to current efficiency, voltage, power density was observed. The dielectric constant of the water/methanol solvent mixtures at 10%, 20%, 40% and 100% volume percent of methanol in water are approximately 75, 72, 64 and 33, respectively. The dielectric constant of the water/ethylene glycol solvent mixtures at 10%, 20%, 40% and 100% volume percent of ethylene glycol in water are approximately 77, 75, 68 and 37, respectively. It is expected that mixing other solvents with water to achieve similar ranges of a dielectric constant (before ion dissolution) can lead to similar benefits. Some examples of solvents that may be used directly, or mixed with water a given proportion that may achieve similar dielectric constant ranges include acetone, acetic acid, acetonitrile, butanol, ethanol, ethylene glycol, formic acid, furfural, glycerol, glycerine, isopropanol, methanol, tetrahydrofuran, propanol, propylene glycol, xylitol, other alcohols/polyols/glycols, among others.

It has been found that using a solvent mixture that results in a lower diffusion coefficient of H⁺ and/or OH⁻ ions, when compared to their diffusion coefficient in water, improves performance. Having a diffusion coefficient of H⁺ less than 9.3*10⁻⁹ m²/s was found to be effective. Having a diffusion coefficient of H⁺ in the range of 1*10⁻⁹ m²/s to 9.3*10⁻⁹ m²/s was found to be effective. Having a diffusion coefficient of H⁺ in the range of 3*10⁻⁹ m²/s to 9.3*10⁻⁹ m²/s was found to be effective. Having a diffusion coefficient of H⁺ in the range of 5*10⁻⁹ m²/s to 9.3*10⁻⁹ m²/s was found to be effective. Having a diffusion coefficient of OH⁻ less than 5.3*10⁻⁹ m²/s was found to be effective. Having a diffusion coefficient of OH⁻ in the range of 1*10⁻⁹ m²/s to 5.3*10⁻⁹ m²/s was found to be effective. Having a diffusion coefficient of OH⁻ in the range of 2*10⁻⁹ m²/s to 5.3*10⁻⁹ m²/s was found to be effective. Having a diffusion coefficient of OH⁻ in the range of 3*10⁻⁹ m²/s to 5.3*10⁻⁹ m²/s was found to be effective. As an example, as described in this document the diffusion coefficient of H⁺ in a 20% by volume methanol in water solution is approximately 6.06*10⁻⁹ m²/s, and better performance including a higher current efficiency was observed. Similarly the diffusion coefficient of H⁺ in a 40% by volume methanol in water solution is approximately 3.9*10⁻⁹ m²/s, and better performance, including a higher current efficiency was observed. A similar reduction in the diffusion coefficient of OH⁻ is expected to occur with addition of a similar solvent. It is expected that the addition of other solvents may achieve a similar reduction in the H⁺ and/or OH⁻ diffusion coefficients.

In view of the above it should be apparent that, in a SPED flow battery and/or FBPED and/or RBPED, a solvent may be used to reduce the freezing temperature of the system to below 0 degrees Celsius.

The solvent may reduce the diffusion coefficient of the acid and/or conjugate base, as compared to its diffusion coefficient in water. The solvent may have any one or more of the following attributes:
The solvent is polar;
The solvent is non-polar;
The solvent is organic;
The solvent has a hydroxyl group;
The solvent is an alcohol, such as ethanol, propanol, isopropanol, etc.;
The solvent may dissolve ionic salts;
The solvent is fully miscible with water;
The solvent is partially miscible with water;
The solvent has a freezing point lower than 0 degrees Celsius;
The solvent may undergo dissociation into cations and anions under strong electric field at a bipolar membrane interface wherein the following properties are conducive to solvent dissociation:
   The solvent has a hydroxyl group;
   The solvent is an alcohol;
   The solvent is polar;
   The solvent may dissociate into a conjugate acid/base pair;
   The solvent may react with water to form a conjugate acid/conjugate base;
   The solvent may dissociate into a cation and an anion;
   The solvent is a weak acid; and/or
   The solvent is a weak base; and/or
The solvent is a mixture of solvents with any of the mentioned properties and/or is mixed with water and/or is mixed with methanol.

A solvent is used in a flow battery may reduce the diffusion coefficient of the acid and/or conjugate base, compared to its diffusion coefficient in water. The solvent may have one or more of the following attributes:
The solvent is polar;
The solvent is non-polar;
The solvent is organic;
The solvent has a hydroxyl group;
The solvent is an alcohol, such as ethanol, propanol, isopropanol, etc.;
The solvent may dissolve ionic salts;
The solvent is fully miscible with water;
The solvent is partially miscible with water;
The solvent has a freezing point lower than 0 degrees Celsius;
The solvent may undergo dissociation into cations and anions under strong electric field at a bipolar membrane interface wherein the following properties are conducive to solvent dissociation:
   The solvent has a hydroxyl group;
   The solvent is an alcohol;
   The solvent is polar;
   The solvent may dissociate into a conjugate acid/base pair;
   The solvent may react with water to form a conjugate acid/conjugate base;
   The solvent may dissociate into a cation and an anion;
   The solvent is a weak acid; and/or
   The solvent is a weak base; and/or

The solvent may be a mixture of solvents with any of the mentioned properties and/or is mixed with water and/or is mixed with methanol. The solvent may form an acidic/basic compound through dissociation at the BPM interface for use in a BPED flow battery and/or FBPED and/or RBPED. The solvent may have one or more of the following attributes:
The solvent is polar;
The solvent is non-polar;
The solvent is organic;
The solvent has a hydroxyl group;
The solvent is an alcohol, such as ethanol, propanol, isopropanol, etc.;
The solvent may dissolve ionic salts;
The solvent is fully miscible with water;
The solvent is partially miscible with water;
The solvent has a freezing point lower than 0 degrees Celsius;
The solvent may undergo dissociation into cations and anions under strong electric field at a bipolar membrane interface wherein the following properties are conducive to solvent dissociation:
   The solvent has a hydroxyl group;
   The solvent is an alcohol;
   The solvent is polar;
   The solvent may dissociate into a conjugate acid/base pair;
   The solvent may react with water to form a conjugate acid/conjugate base;
   The solvent may dissociate into a cation and an anion;
   The solvent is a weak acid; and/or
   The solvent is a weak base; and/or

The solvent may be a mixture of solvents with any of the mentioned properties and/or is mixed with water and/or is mixed with methanol. Operation of forward and/or reverse BPED where a methanol and water-based solvent is used for the streams, where the methanol hinders H⁺ and OH⁻ diffusion, and reduces the freezing point of the solvent, compared to water,. The following techniques may further be used:
the methanol water solvent is used in all three streams: acid, base, salt;
the methanol water solvent is used in just the acid stream, with water-based solvent used for the base and salt stream;
the methanol water solvent is used in just the base stream, with water-based solvent used for the acid and salt stream;
the methanol water solvent is used in just the salt stream, with water-based solvent used for the base and acid stream;
the methanol water solvent is used in both the acid and base streams, with water-based solvent used for the salt stream;
the methanol water solvent is used in both the acid and salt streams, with water-based solvent used for the base stream; or
the methanol water solvent is used in both the salt and base streams, with water-based solvent used for the acid stream.

Operation of a BPED flow battery and/or methanol/water-based system, where the methanol and/or the water solvents are split into acidic and basic compounds at the bipolar junction, may use the following techniques:
the methanol water solvent is used in all three streams: acid, base, salt;
the methanol water solvent is used in just the acid stream, with water-based solvent used for the base and salt stream;
the methanol water solvent is used in just the base stream, with water-based solvent used for the acid and salt stream;
the methanol water solvent is used in just the salt stream, with water-based solvent used for the base and acid stream;
the methanol water solvent is used in both the acid and base streams, with water-based solvent used for the salt stream;
the methanol water solvent is used in both the acid and salt streams, with water-based solvent used for the base stream; or.
the methanol water solvent is used in both the salt and base streams, with water-based solvent used for the acid stream.

Operation of a BPED flow battery system with water and methanol at temperatures below 0 degrees Celsius, as the methanol has a lower freezing point than water, may use the following techniques:
the methanol water solvent is used in all three streams: acid, base, salt;
the methanol water solvent is used in just the acid stream, with water-based solvent used for the base and salt stream;
the methanol water solvent is used in just the base stream, with water-based solvent used for the acid and salt stream;
the methanol water solvent is used in just the salt stream, with water-based solvent used for the base and acid stream;
the methanol water solvent is used in both the acid and base streams, with water-based solvent used for the salt stream;
the methanol water solvent is used in both the acid and salt streams, with water-based solvent used for the base stream; or
the methanol water solvent is used in both the salt and base streams, with water-based solvent used for the acid stream.

In addition to the above, other solvents may be used as the solvent in a BPED flow battery and/or FBPED and/or RBPED, including but not limited to:
Ammonia;
Acetic Acid;
Ethanol;
1-propanol;
Isopropanol; and/or
The solvent may have the following properties:
   The solvent is polar;
   The solvent is non-polar;
   The solvent is organic;
   The solvent has a hydroxyl group;
   The solvent is an alcohol, such as ethanol, propanol, isopropanol, etc.;
   The solvent may dissolve ionic salts;
   The solvent is fully miscible with water;
   The solvent is partially miscible with water;
   The solvent has a freezing point lower than 0 degrees Celsius;
   The solvent may undergo dissociation into cations and anions under strong electric field at a bipolar membrane interface wherein the following properties are conducive to solvent dissociation:
      The solvent has a hydroxyl group;
      The solvent is an alcohol;
      The solvent is polar;
      The solvent may dissociate into a conjugate acid/base pair;
      The solvent may react with water to form a conjugate acid/conjugate base;
      The solvent may dissociate into a cation and an anion;
      The solvent is a weak acid; and/or
      The solvent is a weak base; and/or
   The solvent is a mixture of solvents with any of the mentioned properties and/or is mixed with water and/or is mixed with methanol.

In addition to the above, any of the solvents discussed elsewhere herein may be used in place of the water-based solvent

Another polar solvent may be used in place of methanol to hinder H⁺ or OH⁻ diffusion by interrupting the H₂O percolation and disrupting the Grotthuss mechanism. The solvent may have one or more of the following attributes:
The solvent is polar;
The solvent is non-polar;
The solvent is organic;
The solvent has a hydroxyl group;
The solvent is an alcohol, such as ethanol, propanol, isopropanol, etc.;
The solvent may dissolve ionic salts;
The solvent is fully miscible with water;
The solvent is partially miscible with water;
The solvent has a freezing point lower than 0 degrees Celsius;
The solvent may undergo dissociation into cations and anions under strong electric field at a bipolar membrane interface wherein the following properties are conducive to solvent dissociation:
   The solvent has a hydroxyl group;
   The solvent is an alcohol;
   The solvent is polar;
   The solvent may dissociate into a conjugate acid/base pair;
   The solvent may react with water to form a conjugate acid/conjugate base;
   The solvent may dissociate into a cation and an anion;
   The solvent is a weak acid; and/or
   The solvent is a weak base; and/or

The solvent may be a mixture of solvents with any of the mentioned properties and/or is mixed with water and/or is mixed with methanol. The solvent may allow for operation of flow batteries in general at temperatures below the freezing point of water.

The solvent may allow for operation of FBPED and/or RBPED at temperatures below the freezing point of water.

The solvent may allow for operation of a BPED flow battery at temperatures below the freezing temperature of water.

The techniques further include the operation of a BPED flow battery and/or FBPED and/or RBPED where the acid and/or base streams are operated at a lower temperature than the rest of the streams to reduce the diffusion coefficient of the acidic cation and/or basic anion in the solvent.

The techniques further include the operation of a BPED flow battery and/or FBPED and/or RBPED where the acid and/or base streams are operated at a temperature lower than 0 degrees Celsius to reduce the diffusion coefficient of the acidic cation and/or basic anion in the solvent, with a solvent that reduced the freezing point temperature of the solvent below 0 degrees Celsius.

The techniques further include a mixture of solvents discussed elsewhere herein to reduce a diffusion coefficient, reduce the operating temperature and/or have the solvent split at the BPM interface, where each of these may be achieved independently through different components of a solvent mixture.

### Permeable Bipolar Membrane

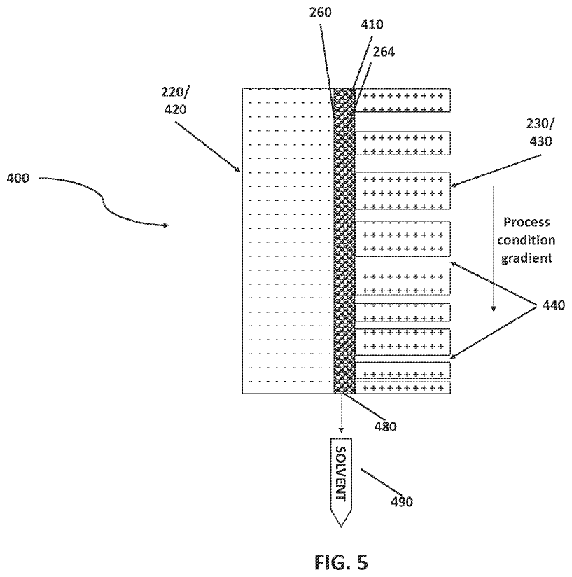

FIG. 5 shows a permeable bipolar membrane, indicated generally at 400. The permeable BPM 400 includes a permeable CEL 420 or CEL 220, a permeable AEL 430 or AEL 230, solvent permeation layer (SPL) 410, BPM interface 260, and catalyst 264. The permeable AEL 430/CEL 420 has more permeability for the solvent than the AEL 230/CEL 220, and allows solvent to flow from (or to) the BPM interface 260 in the through plane direction of the permeable BPM 400. The SPL 410 may allow solvent generated at the BPM interface to flow through it in the through plane and/or in plane direction of the BPM. The SPL 410 may also transport ions to/from the BPM interface 260 to/from the AEL/CEL. The BPM interface may be adjacent to the SPL 410 or within the SPL 410 depending on where anion exchange material meets cation exchange material. The catalyst should be present near/at the BPM interface may be anywhere throughout the permeable BPM. The AEL 430/230 and/or CEL 420/220 may be replaced by any suitable ion exchange material.

### Catalyst

A catalyst 264 may be used in the BPM interface to help split the solvent. For water-based solvents, iron-or aluminum-based catalysts may be used. The catalyst 264 may be applied to the surface of the CEL/AEL, dispersed throughout the CEL/AEL, in the SPL, on ion exchange resin, or anywhere on or within any ion exchange polymer or binder material.

A solvent molecule may diffuse to the surface of the catalyst and adsorb to the catalyst 264. No electron transfer occurs and the solvent molecule is dissociated to an anion and cation, such as an acid and conjugate base (H⁺/OH⁻ for H₂O). The catalyst may be in contact with both anion exchange and cation exchange polymer where the solvent splits so that anions and cations generated diffuse through their corresponding ion exchange polymer.

For RBPED operation, a catalyst 264 (or a mechanism to split solvent at the BPM) does not need to be present to harness the stored energy in the BPED split solvents. Two systems may be used, one to split the solvent, and a separate one to harness the stored energy. For efficient operation, the catalyst should be present in a way that allows solvent permeation while maintaining a high surface area of BPM interface. Catalysts for water-based solvents may be iron or aluminum. Catalysts for other solvents may be used.

For cold temperature operation to be effective the activity of the catalyst should be high. A combination of a BPM interface with an extremely high surface area, paired with catalyst particles will increase the kinetics of the dissociation reaction. Catalyst particles that are well dispersed in and on the ion exchange polymer, that have a high surface area will increase the performance/kinetics splitting any solvent.

The catalyst 264 may be applied in several ways, including by electrospraying or electrospinning a layer of cation and/or anion exchange polymer mixed with catalyst. The catalyst loading may be controlled to affect the surface area and/or concentration of the catalyst particles in the BPM interface.

The catalyst 264 may be used for both water and for methanol (or other solvent), or separate catalysts for water and methanol (or other solvent) may be used. The water dissociation reaction may be catalyzed using iron or aluminum among several other catalysts. The methanol splitting reaction may also be catalyzed. While water splitting may be the predominant reaction occurring to store energy, the methanol (or other solvent) splitting may make up a significant part of the energy stored. This may be promoted/enhanced through the use of a catalyst. This catalyst may be applied to the IEMs (cation or anion), between the IEMs, or in a bed of ion exchange resin. It may be applied to the anion resin, cation resin, the polymer binder, as separate particles, or anywhere within the bipolar membrane or interface between membranes. Water and methanol and any other solvents may be applied/replaced in the context of the previous section on catalyst.

Forward BPED was tested using a methanol solvent to evaluate the effectiveness of a catalyst for splitting of solvents other than water. Sodium chloride was dissolved in a methanol solution, >99% pure, to obtain a 0.15 molar solution of NaCl in methanol. The membranes were soaked in this solution prior to testing. It was pumped through a BPED cell. One cell had a BPM with an iron-based catalyst present, and one had a BPM with the same type of membrane material and thickness of AEL and CEL without catalyst present. The cell was operated at a constant current at 0.8 A. The pH was measured in the acid and base streams at 2 and 10, respectively, to confirm that the solvent was being split into acidic and basic ions. The voltage of the cell triplet for the charge was measured at 5 V, when a catalyzed membrane was used. The voltage of the cell triplet for the uncatalyzed membrane was higher, at 7.1 V. This may indicate that the dissociation reaction requires less energy to perform with a catalyst present, showing the catalyst aids in solvent splitting. Other types of catalysts that facilitate the dissociation of water and methanol may also work for the dissociation of water, such as aluminum-based catalysts, iron-based catalysts, or other catalysts used in bipolar membranes. That catalysts used for dissociation of water and/or methanol may be also used to facilitate dissociation of other similar solvents.

To show the effect of the catalyst on the methanol dissociation reaction, a solvent of solely methanol was used in testing. Another system may use a mixture of methanol and water to be more efficient and/or take advantage of well-designed membranes for use with water.

In view of the above, it should be apparent that a catalyst may be used in a BPM and/or BPM interface to facilitate splitting/dissociation of solvents that lower the freezing temperature in BPED flow batteries and/or FBPED and/or RBPED.

A catalyst may be used in a BPM and/or BPM interface to facilitate splitting of solvents that interrupt the Grotthuss mechanism in BPED flow batteries and/or FBPED and/or RBPED.

A catalyst may be applied in a BPM and/or SPL and/or BPM interface by electrospinning or electrospraying a mixture of catalyst and ion exchange polymer or material. A catalyst may be used in a BPM and/or BPM interface to split multiple solvents which may include water, methanol or any other solvents for use in BPED flow batteries and/or FBPED and/or RBPED.

A catalyst may be used in FBPED and/or RBPED and/or a BPED flow battery, where:
The catalyst is iron based;
The catalyst is aluminum based; and/or
The catalyst works for splitting/dissociation of water.

### Permeable AEL/CEL

The permeable AEL 430 and permeable CEL 420 are described in more detail. An AEL 430 or a CEL 420 of a permeable BPM 400 may have any type and arrangement of openings 440, such as holes, perforations, cracks, etc., that allow for solvent 300 flow in the through plane direction of the membrane. The AEL 430 and/or CEL 420 may be designed with an inherently permeable structure. The permeable AEL 430 and/or CEL 420 may undergo changes in permeability under various process conditions like concentration and/or composition, among others.

The solvent 300 generated at the BPM interface 260 may flow out through the perforations 440 or through the inherently permeable AEL 430 and/or CEL 420 to the acid compartment 142 and/or base compartment 152.

The permselectivity has a component that is related to the solvent transport, and to the ion transport. If the membrane is not sufficiently selective to blocking solvent transport, the permselectivity of the membrane may be lower. This means that the membrane may allow more contamination. There may be a tradeoff for BPED systems, where a BPM 400 permeable to solvent 300 is desirable to prevent solvent accumulation in between the AEL 430 and CEL 420 during RBPED, but a sufficiently permselective AEL 430 and CEL 420 are desired for effective operation of FBPED, when splitting the solvent 300 and transporting ions across the membrane.

A preferred embodiment may include permeability for the solvent to flow, while being sufficiently permselective for splitting solvent. A preferred embodiment may include an AEL 430 and/or CEL 420 that changes permeability depending on process conditions. An ion exchange membrane (IEM) may swell under various conditions such as the degree of hydration, type/amount of solvent present, type of solute present, or concentration of solute. For example, higher and lower concentrations of the membranes will cause different degrees of swelling of the membrane. Openings 440 may be introduced to the membrane structure that allow for permeability of solvent 300, so that effective RBPED operation may occur. A change in process conditions may be applied during FBPED operation such that the AEL 430 and/or CEL 420 have a lower solvent permeability. This may lead to more effective solvent splitting operation and/or cation/anion transport through the AEL/CEL, and a higher permselectivity, with the option for solvent flow through the AEL 430 and/or CEL 420.

Permeability to the AEL 430/CEL 420 may be applied in several ways. Holes may be perforated. Neutron track etching may be used. Cracking may be caused in brittle membranes. Any other type of through-plane permeability for the AEL/CEL may be used. Any shape of openings 440 may be used, with the flow channels in any direction. Various other techniques may be used to create the openings 440.

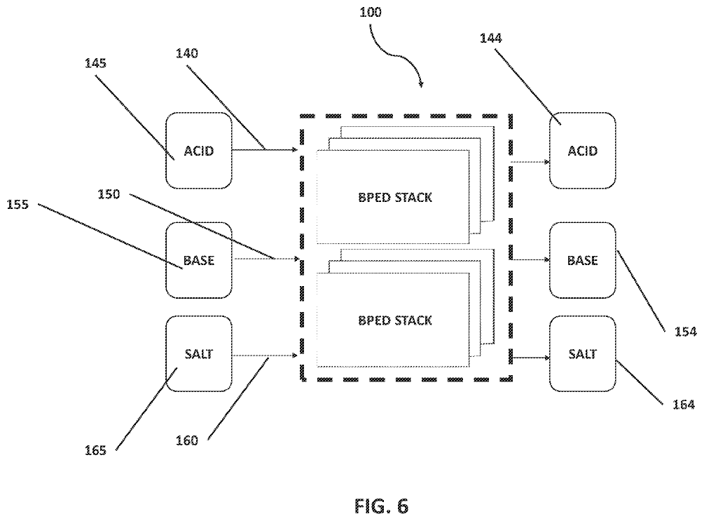

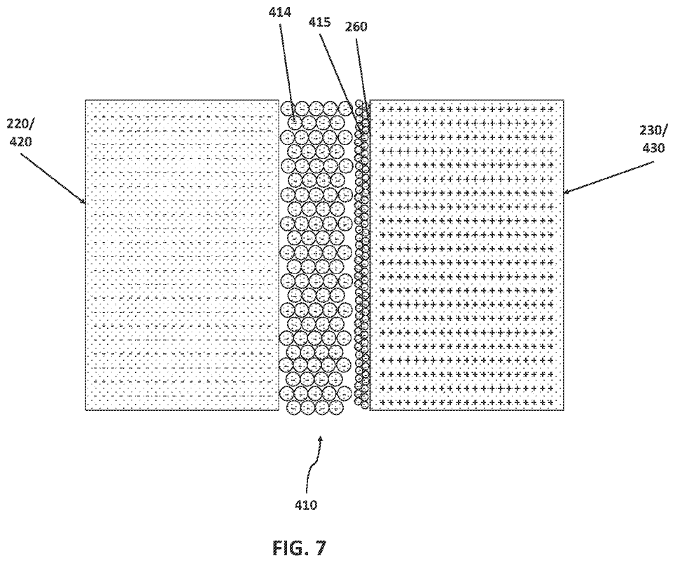

An example of how the system may be operated to achieve changing process conditions to change the BPM 400 permeability is depicted for FBPED in FIG. 6 and RBPED in FIG. 7. In this embodiment, the AEL 430 and/or the CEL 420 are more permeable under a higher concentration of base/salt and acid/salt, respectively. During FBPED operation, one tank 144, 154, 164 per stream may be used and over time the concentration in the tanks may change as the respective streams 140, 150, 160 are looped through the BPED stack(s). The acid and base streams may be diluted through the charging process until fully charged. Then once a certain concentration in the acid stream 140 and/or base stream 150 is achieved, the AEL 430 and/or CEL 420 will become more permeable. At this point the system may be operated in RBPED mode to discharge. Here, a separate inlet tank 145, 155, 165 and outlet tank 144, 154, 164 may be used for each stream. This is to encourage maintaining a high concentration of acid stream 140 and base stream 150 over the discharge period. The same BPED stack or multiple BPED stacks in parallel may be used during the discharge process to accommodate a potentially lower flow rate during the RBPED operation given the inlet and outlet tank constraint. The multiple stacks in parallel may operate with the same BPM as used in FBPED or different BPMs that are only tailored for RBPED operation (i.e., without the same constraints needed to split solvent).

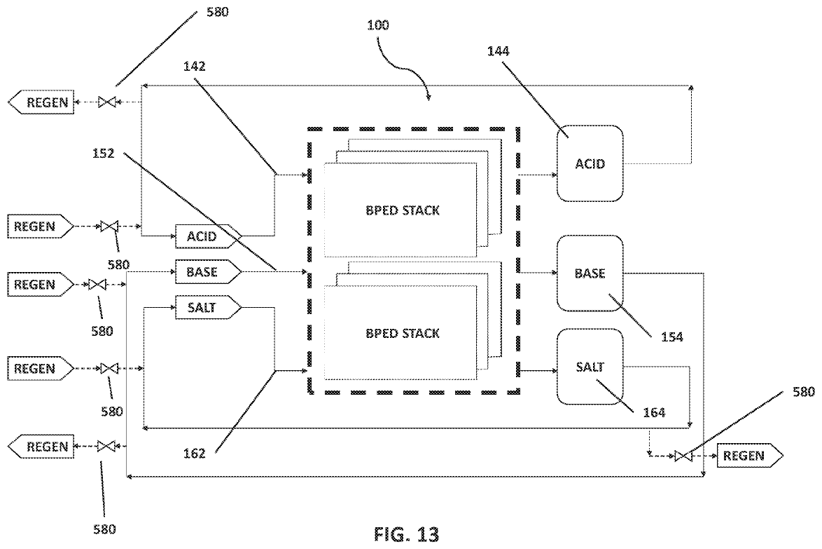

Variations of how to manipulate the concentrations to maintain a high concentration for the Acid and Base streams are described in greater detail. Several BPED stacks 100 (two are depicted, one or many may also work) may operate as shown in FIGS. 6 and 13. During FBPED operation (charging), all of the stacks may operate hydraulically in series or parallel, and run in a loop where the concentration of the streams change as the system is charged, from running in the same tank. The reverse system may operate hydraulically in parallel to maintain high concentration. For this system, a high current density may be applied for one pass through the system. This would maintain the membrane at a high enough concentration that ion exchange polymer in the BPM 400 is in the permeable state during RBPED operation. This may cause a gradient in concentration and in permeability of the BPM 400, as depicted in FIG. 5 where the openings 440 change size down the membrane.

Pathways for water to flow may be introduced into the membrane. These may be applied in a way that doesn't limit the selectivity of the membranes. Cracks in the BPM are one example. The cracks may go through the entire membrane or only partially penetrate the membrane. Penetrations to the membrane surface may also be used, including but not limited to pinholes in the membrane, or much finer perforations achieved by techniques like neutron track etching.

Cracks may be applied chemically or physically. An example of a chemically formed crack may be application of a strong acid to the membrane. This, or other similar chemicals may cause the anion exchange membrane, or the cation exchange membrane's permeability to water increase significantly. The change in permeability may be due to the change in size of the membrane structure under different concentrations of different solutions. Upon application of a strong acid for example, the membrane structure may shrink to a degree that mechanical stresses cause changes to the membrane structure, creating additional pathways for solvent flow through for example cracks and/or ruptures and/or similar perforations in the membrane structure which may be an example of heterogeneous permeability. Another example of permeability introduced in this manner may be from the pore and/or throat sizes in the membrane increasing due to the membrane structure shrinking, which may be an example of homogeneous permeability. This increase in pore/throat size and/or heterogeneous permeability may be enough that the size of the pore/throat/pathway for flow is large enough that the capillary pressure/breakthrough pressure is reduced enough that more pressure solvent driven flow may occur from the BPM interface out to the flow channels. This permeability may be controlled through manipulating the size of the membrane structure and the pores/throats/pathways for flow, through for example the type and/or concentration of the solution the membrane is in contact with. These changes to the membrane structure may be reversible, irreversible, or a combination of reversible and irreversible changes. The perforations may then change size so that the permeability to solvent is reduced, upon changing either the concentration of the acid in contact with the membrane, or putting the membrane in contact with a different salt, base or other solution, at the same or a varied concentration and/or solvent composition.

Preferably, the permeable membrane should be able to withstand the pressure generated from solvent accumulation at the BPM interface or be permeable enough to prevent the accumulation of such pressure.

### Supporting Data

It was shown that for commercially available ion exchange membranes, with permeability introduced to the membrane that the permeability changes under different conditions. Perforations were introduced to a CEM to create additional permeability to the membrane. The membrane was soaked in deionized water. The flow through the membrane was measured at 125 ml/min. The same membrane was then soaked in a 1 molar salt solution. The flow through the membrane was measured at 175 ml/min with the same applied pressure, an increase of 40%. The membrane size was measured in the deionized water, and in the 1 molar salt solution. The membrane was 1% smaller in the in-plane direction in the 1 molar salt solution. In this case, with a smaller membrane structure there may be larger pore space and/or throat space/diameter, therefore reducing the capillary pressure through the membrane and allowing more flow through. As such it is seen that with changes to the membrane structure under different solution compositions, the permeability of the membrane may be controlled/manipulated. The permeability and/or relative change in permeability may be controlled with a specific distribution of pores, throats, or perforations or other ways of obtaining permeability or flow paths through the membrane at higher and/or lower ranges of membrane permeability. While this is one example, the permeability may be controlled to allow for pressure generated at the BPM interface 260 and/or SPL 410 to be dissipated. It may also be designed to have a permeability that is low enough to maintain membrane selectivity. It should be understood that similar phenomena may be observed for various types of IEMs including CEMs, AEMs and/or BPMs.

Commercial membranes may have a pressure driven permeability on the order of 1*10⁻¹⁴ m³/s/Pa/m². BPM delamination has been observed in studies where the current density exceeds 30 A/m². This corresponds to a water accumulation rate of 5.59*10⁻⁷ m³/s/m². At this rate of generation, a pressure of 56 MPa will build up in the BPM interface to achieve a steady state where the solvent will flow out of the membrane for the example of a membrane with a hydraulic permeability of 1*10⁻¹⁴ m³/s/Pa/m². At this ‘delamination pressure’, the AEL and CEL separate. A 5-fold or 100-fold increase in the permeability of the membrane will allow for operation of RBPED at current densities higher 5× to 100× higher, at current densities where migration would be the main transport process, far outweighing any diffusion processes that contribute to reduced current efficiency. It is worth noting that these reported permeabilities are one example of commercially available membranes, where other membranes with higher permeability are achievable and sufficiently permselective. An AEL's and/or CEL's permeability may be increased while the membrane is in a state of a low salt/acid/base concentration so that it is still permselective for effective operation for FBPED, and then when it is operated for RBPED, it will be in a state of higher salt/acid/base concentration, and more permeable where the generated solvent may escape. A preferred embodiment may have permeabilities in the ranges of 1*10⁻⁹ m³/s/Pa/m²-9*10⁻¹² m³/s/Pa/m², but several other permeability ranges may work, including higher and/or lower permeabilities.

Just enough permeability may be introduced to the AEL and/or CEL so that under high concentration solutions, the solvent accumulated in the BPM may flow out through the AEL and/or CEL at high current densities during RBPED operation. During FBPED operation, the permeability may be reduced by using lower concentration solutions to improve the membrane selectivity, which may be a function of the solvent permeability through the membrane. Alternatively, a separate unit may be used for FBPED and RBPED systems, with the RBPED system having highly permeable membranes, and the FBPED system having low permeability, high selectivity membranes.

To exemplify the case of solvent composition changing the membrane structure and size, an AEM was measured first soaked in deionized (DI) water, then in pure methanol, and the size was different by 1.4%. As previously mentioned herein, alcohol solvents cause the membrane structure to change size, such as swelling. It was further experimentally confirmed with ethylene glycol that the AEL swelled by an average of 1.1% 20% ethylene glycol 0.5 M solution. For different membrane chemistries and/or different solvents swelling and/or shrinking may be attained in the CEL and/or the AEL depending on the membrane-solvent interactions. Swelling of the membranes may contribute to higher permselectivity. Higher permselectivity of the BPM, for example in the AEL, may result in less co-ion transfer such as Na⁺ ions from the base compartment crossing the AEL, and ultimately through the CEL to the acid compartment. Similarly, higher permselectivity of the BPM, for example in the CEL, may result in less co-ion transfer such as Cl ions from the acid compartment crossing the CEL, and ultimately through the CEL to the acid compartment. The reduced co-ion transfer will result in a lower self-discharge of the BPED flow battery (from acidic protons and basic anions undesirably reacting at the BPM interface) and may contribute to a higher current efficiency (as observed in the solvent supporting data section). This reduced flux of Na⁺ and Cl⁻ in the BPM may also result in a higher H⁺ and OH⁻ concentration in the CEL and AEL, respectively, increasing the junction potential and correspondingly the power density.

The open circuit voltage of the cell triplet was measured as a function of the amount of ethylene glycol solvent present. Solutions of 0.5 M HCl, 0.5 M NaOH and 0.5 M NaCl were prepared with 0%, 10% and 20% ethylene glycol in water solvent mixtures. They were then flowed through the built BPED flow battery in their respective channels (HCl in acid compartment, NaOH in base compartment, NaCl in salt compartment), at 50 mL/min/cell, and the open circuit voltage was measured using platinum (Pt) wire pseudo reference electrodes. The Pt wires were placed in the acid compartments against the BPM near the inlet and sealed with Teflon tape. The open circuit voltages were measured at 0.73 V, 0.83 V and 0.85 V, for the 0%. 10% and 20% ethylene glycol solutions, respectively. This data may suggest an increase in the permselectivity of the membranes, which may arise from changes in the membrane structure due to the solvent such as swelling (which may change the pore structure/permeability of the membrane) to cause the increase in open circuit voltage. These experimental observations support the teachings presented herein. The higher junction potential observed at open circuit voltage was also observed when electric current was applied, with similar increases present. This therefore increases the power density of the BPED flow battery. A benefit of using ethylene glycol or other solvent mixtures that modify the ion exchange polymer interactions may also lead to a higher power density.

In a preferred embodiment, the solvent mixture may only need to flow through one of the streams to observe benefits of the increased selectivity, open circuit voltage and/or power density. For example, a solvent mixture containing ethylene glycol and water may flow through the base stream, which may cause the AEL to change properties. In this embodiment the acid and salt streams may have a different solvent composition, for example just water and their respective dissolved ions, to reduce resistive losses that may be associated with including a co-solvent.

In various embodiments, a permeable AEL may be used with a with a non-permeable CEL and vice versa

In various embodiments, swelling/shape changing to tune parameters such as permeability may apply to homogeneous membranes, heterogeneous membranes, ion exchange resin, ion exchange resin wafers, etc.

In various embodiments, staged charge or discharge cycles with stacks hydraulically in series (and/or parallel) may be used to achieve concentration/composition profiles which may control the permeability of the membranes.

An AEL and/or CEL of a BPM may be provided with a pressure driven permeability to the solvent in the same direction as the electric field, i.e., thru plane of membrane in BPED flow batteries and/or FBPED and/or RBPED.

An AEL and/or CEL of a BPM may be provided with a pressure driven permeability to the solvent in the same direction as and/or opposite to and/or perpendicular to the electric field, where at high current densities for RBPED, the pressure at the BPM interface and/or SPL is maintained lower than the pressure to delaminate the BPM.

A permeable AEL and/or CEL of a BPM that, under a given set of process conditions related to composition and concentration, may be configured to change solvent permeability under different process conditions in BPED flow batteries and/or FBPED and/or RBPED, wherein:
An AEL and/or CEL is more permeable under higher concentrations of salt/base/acid, and less permeable under lower concentration of acid/base/salt;
An AEL and/or CEL that is more permeable under lower concentrations of acid/salt/base;
An AEL and/or CEL that is more permeable under certain chemicals such as strong acids and/or strong bases;
An AEL and/or CEL that is more permeable under other chemicals or solvents or solutes with a purpose of the solvent being increasing the permeability, where the solvent may or may not be methanol;
An AEL and/or CEL that is less permeable under higher concentrations of acid/salt/base;
An AEL and/or CEL that is more or less permeable under different ratios of solvent material; and/or
An AEL and/or CEL that is more or less permeable under different ratios of solvent of a water/methanol mixture.

A permeable AEL and/or CEL of a BPM may be configured to change its permeability due to a change in shape of the membrane structure such as swelling or shrinking in BPED flow batteries and/or FBPED and/or RBPED.

A permeable AEL and/or CEL of a BPM may include flow paths through the membrane sized to make up the permeability that may be controlled by changing the size/diameter of these flow paths through changes in process conditions to cause a change in the breakthrough/capillary pressure of the flow paths to prevent and/or allow pressure driven flow in BPED flow batteries and/or FBPED and/or RBPED.

The AEL/CEL of a 8PM may be designed thinner at the inlet and/or outlet to have less resistance to flow near a region where it is desirable for the solvent to exit the membrane such as the inlet and/or outlet region of a cell triplet/BPM in BPED flow batteries and/or FBPED and/or RBPED.

An AEL and/or CEL in the BPM may be made with cracks present, allowing for water formed from the mixing of H⁺ and OH⁻ to escape.

An AEL and/or CEL in the BPM may be made with cracks present, allowing for solvent formed from the reaction of an acidic cation and a basic anion to escape during RBPED.

Perforations in the BPM may be provided to allow for solvent to flow, preventing a buildup of solvent in between the AEL and CEL for RBPED and/or BPED flow batteries.

Highly concentrated solutions may be flowed through a BPED flow battery and/or FBPED system and/or RBPED system to cause the membrane to change shape and crack and/or cause changes to the membrane structure that introduce permeability, and then semi-reversibly seal itself by applying solutions of different concentration.

A membrane structure for the AEL/CEL of a BPM may be provided with inherent permeability to allow solvent flow out of the BPM during RBPED, wherein the permeability may or may not change significantly as a function of process conditions.

### Solvent Permeation Layer

The solvent permeation layer (SPL) 410 is defined as a permeable layer that exists in between the AEL 430, 230 and the CEL 420, 220. The layer may be made of material that conducts ions, or any other material, ion conductive or not. It may allow solvent to flow in between the AEL 430, 230 and CEL 420, 220. Material that is or is not conductive to ions in general may be used as support. The SPL 410 may or may not be structurally bound to the AEL 430, 230 and/or CEL 420, 220 or itself through use of a binder. The SPL 410 should be conducive to allowing for water dissociation to happen. The SPL 410 may be conductive to heat, as elaborated on elsewhere herein.

The BPED process may operate with or without solvent 300 flowing through the SPL 410. While the SPL is designed to allow solvent 300 flow, the FBPED process does not need this. During RBPED, because generation of solvent 300 occurs, solvent flow may be induced by the generation of solvent in a constricted area, causing a pressure distribution that will cause the solvent 300 to flow to an area with lower pressure. If a separate manifold and/or outlet 480 is in fluid communication with the SPL 410, this outlet 480 may be kept at a lower pressure to allow solvent 300 to flow out of the SPL 410 or BPM interface 260 in a solvent accumulation stream 490. The flow stream 419 through the SPL 410 may be present for RBPED and/or FBPED operation. It may be more advantageous to have the SPL stream 419 in RBPED to prevent solvent accumulation. If using the SPL 410 to transfer heat, a larger flow rate of the stream 419 may be more advantageous for RBPED operation.

Solvent may also flow in the same direction of the electric field, through the AEL 430, 230 and/or CEL 420, 220. However, permeability of solvent in IEMs is typically low-much lower than the permeability of resin beads or other material that may make up the matrix of the solvent permeation layer. IEMs that are used for the AEL 430, 230 and/or CEL 420, 220 in the BPM 200, 400 may also be designed with a higher solvent permeation rate to offer a path to the flow channels 140/150 for solvent 300 generated in the BPM interface 260 during RBPED. However, it is possible to have a lower permselectivity of the AEL 230, 430 and/or CEL 220, 420 if it is more permeable.

As discussed, a layer may be provided in between the AEL and CEL of a BPM to allow solvent flow during FBPED and/or RBPED and/or BPED flow batteries.

A layer may be provided in between the AEL and CEL of a BPM to allow solvent flow during FBPED and/or RBPED and still allow for solvent dissociation/splitting during FBPED, wherein:
The solvent may flow in the perpendicular direction of the electric field, i.e., along side the membranes;
The solvent may flow in the same direction of the electric field, i.e., through plane of the membranes; and/or
The solvent may flow in a combination of directions, for example through the SPL in the perpendicular direction of the electric field, and then out of the SPL through the membranes.

A layer may be provided in between the AEL and CEL of a BPM that has a matrix of ion exchange material that may or may not be catalysed to allow for solvent to flow between the AEL and CEL during FBPED and/or RBPED and/or BPED flow batteries.

A layer may be provided in between the AEL and CEL of a BPM that is connected to a reservoir (i.e., through a manifold, similar to the acid/base/salt streams) where flow may occur through the solvent permeation layer in BPED flow batteries and/or FBPED and/or RBPED.

A binder may be used to bind ion exchange material together for use in the SPL of a BPM wherein the ion exchange material may or may not be ion exchange resin in BPED flow batteries and/or FBPED and/or RBPED.

A binder that is conductive to ions may be used to bind ion exchange material together for use in the SPL of a BPM, wherein the ion exchange material may or may not be ion exchange resin in BPED flow batteries and/or FBPED and/or RBPED.

A flow path may be provided in between the AEL and CEL of a BPM allowing for solvent generated in the reaction to flow out of the BPM/SPL in BPED flow batteries and/or FBPED and/or RBPED.

A BPM may include a flow path in between and/or integrated within the AEL/CEL where the solvent will flow out of the BPM through an extra manifold, similar to the acid/base/salt manifolds of a BPED and/or RBPED and/or FBPED system.

A BPM may be provided in which the solvent may flow out of the BPM through perforations or cracks or other flow paths back into the acid and/or base and/or salt flow channels in BPED flow batteries and/or FBPED and/or RBPED.

A BPM may be provided with flow paths for pressure driven flow in any direction for solvent in between the AEL and CEL in BPED flow batteries and/or FBPED and/or RBPED.

A BPM may be provided with flow paths for pressure driven flow for solvent that is generated during RBPED.

A BPM may be provided with flow paths for pressure driven flow for solvent to flow and prevent accumulation of solvent in the BPM interface that may lead to delamination of the BPM during RBPED. A material that is conductive to anions and/or cations that allows for solvent flow between the AEL and CEL may be used, while enhancing the conductivity of ions in the BPM in BPED flow batteries and/or FBPED and/or RBPED.

A material that is conductive to anions and/or cations that allows for solvent flow between the AEL and CEL may be used, while enhancing the conductivity of ions in the BPM, when compared to when there is solvent accumulated in the BPM in BPED flow batteries and/or FBPED and/or RBPED.

A BPM where the SPL is patterned in BPED flow batteries and/or FBPED and/or RBPED.

A BPM may be provided in which the SPL is patterned for RBPED systems and/or FBPED and/or BPED flow batteries.

A BPM may be provided in which the SPL is patterned to control solvent flow through the SPL and/or ion exchange resin in the SPL in BPED flow batteries and/or FBPED and/or RBPED.

A BPM may be provided in which the SPL is patterned to control solvent flow through the SPL and/or ion exchange resin in the SPI during RBPED and/or FBPED and/or BPED flow batteries.

A BPM may be provided in which the SPL is patterned using binder to fix the ion exchange material in place, wherein the patterned SPL may be used to control solvent flow for RBPED and/or FBPED and/or BPED flow batteries.

In conjunction with a permeable membrane, a patterned SPL in a BPM that directs solvent flow towards a region where the AFL/CEL is more permeable to through plane flow, which may depend on the concentration profile in the cell triplet, such as the inlet and/or outlet in BPED flow batteries and/or FBPED and/or RBPED.

A system may be provided in which the SPL is insulated to heat in BPED flow batteries and/or FBPED and/or RBPED.

A system may be provided in which there is fluid flowing through the SPL that exchanges heat with an external reservoir in BPED flow batteries and/or FBPED and/or RBPED.

### Binder

A binder is a material that will adhere to materials such as ion exchange polymer in resin and membranes. It may or may not be conductive to ions. It may or may not be permeable to water. A binder may be used to hold together IER or other ion exchange polymer.

### Ion Exchange Resin

Ion exchange resin (IER) is made of a polymer that is conductive to ions. An IER may take the form of grains or particles with less than 1 mm in diameter. Their polymer material they are made of is like that of IEMs. They may conduct anions or cations, to be anion exchange resin (AER) 412, cation exchange resin (CER) 414, or if a mixture of AER and CER is used it may be mixed bed resin (MBR) 416.

One example of a material that may conduct ions while allowing solvent flow in a BPM is ion exchange resin. Anion exchange resin (AER) 412, or cation exchange resin (CER) 414 may exist in between the AEL 430, 230 and CEL 420, 220. A mixture of both AER 412 and CER 414 may be used in any ratio. The AER 412 may be placed next to the AEL 430, 230, and/or CEL 420, 220, and the CER 414 may be placed next to the CEL 220, 420 and/or the AEL 230, 430. When a mixture is applied, either a homogeneous mixture of resin may be used, or an ordered application of resin may be used. For example, the AER 412 may be adjacent to the AEL 430, 230 with the CER 414 adjacent to the CEL 420, 220 with the bipolar junction or BPM interface 260 being formed between the AER 412 and CER 414. The AER 412 and CER 414 in this embodiment would be conducting basic anion 154 (OH⁻ for the example of water solvent, CH₃O⁻ for the example of methanol solvent) and acidic cation 144 (H⁺ for the example of water or methanol solvent) to/from the AEL 430, 230 and CEL 420, 220, respectively, without allowing them to recombine and react. Without ordering of the AER/CER it may be more likely for this to occur. The BPM interface 260 may also be between the AEL 430, 230 and the CER 414, or the CEL 420, 220 and the AER 412. The AER 412 and/or CER 414 may also be treated with catalyst to enhance water splitting during the FBPED process. Different size distributions of resin particles may also be used. Fine AER 413 and/or fine CER 415 (i.e, resin with a much smaller size, it may be obtained by manufacturing smaller resin or crushing resin) may be used throughout the SPL 410 to enhance conductivity, at the surface of the membrane to improve contact between the AEL 230, 430 and/or CEL 420,220 and the AER 412 or CER 414, or anywhere else in the SPL 410, in a homogeneous or heterogeneous way. Fine AER 413 or fine CER 415 may also be used at the BPM interface 260 to enhance the surface area and improve solvent 300 splitting. The resin may also have a binder to improve mechanical stability and prevent movement of resin particles. This binder may or may not be conductive to ions.

### Bipolar Membrane With Resin Making Up Solvent Permeation Layer

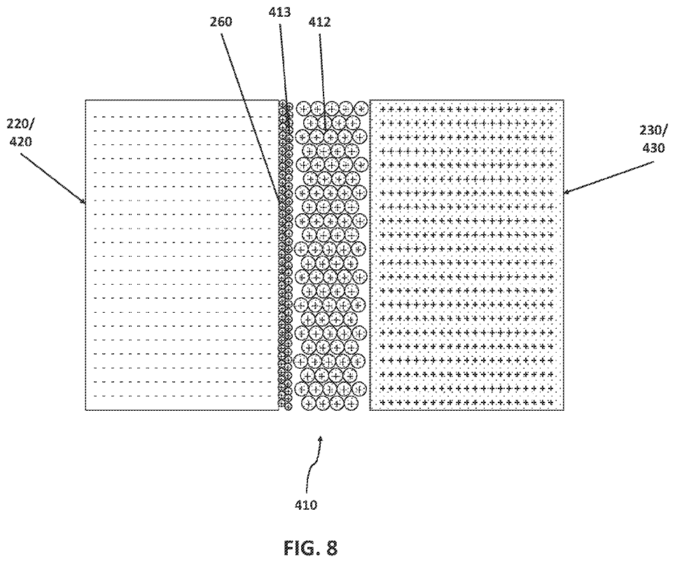

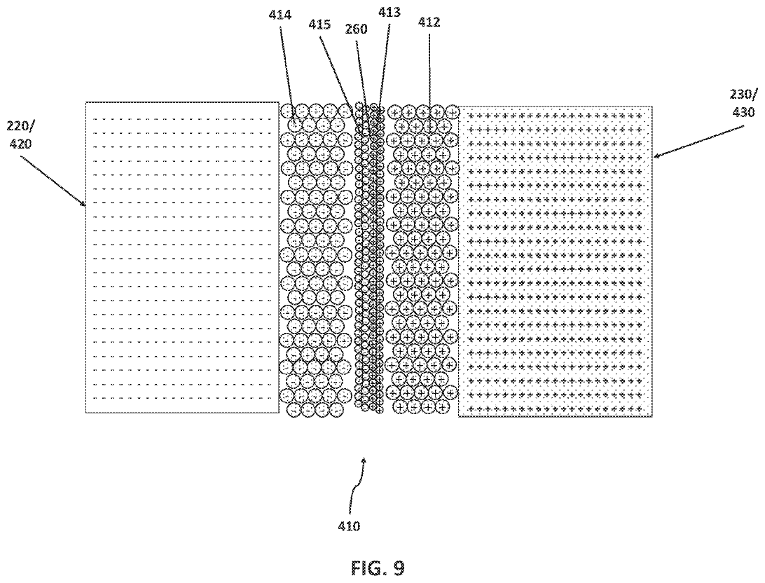

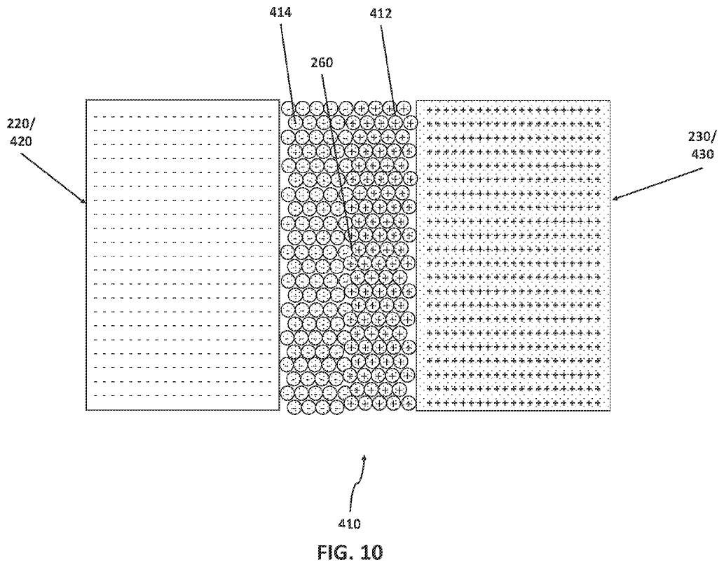

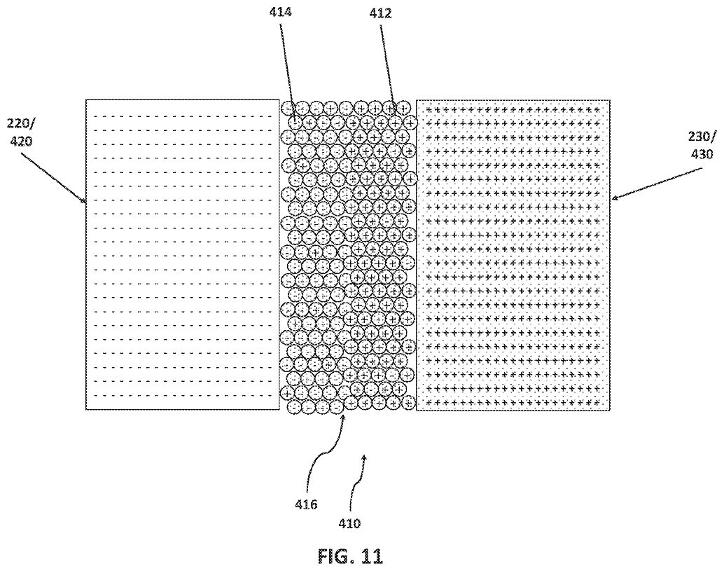

As seen in FIGS. 7-11, AER 412, 413 and/or CER 414, 415 may be within/around the BPM interface 260 and/or SPL 410. Any permutation of AER 412, 413, CER 414, 415 or MBR 416 may be present in the BPM interface 260, SPL 410. The resin layer may be as small as one layer of resin in between the AEL 230, 430 and CEL 220, 420, or as large as several layers of resin. The solvent splitting reaction may take place on the order of nanometers. The resin may take the place of the ion exchange polymer (e.g., AEL/CEL) at the BPM interface 260. The BPM interface 260 works by having cation exchange material in contact with anion exchange material. By replacing one or both, or part of the AEL 430, 230 and/or CEL 420, 220 in the BPM interface 260 with AER 412, 413 and/or CER 414, 415, the interface where solvent 300 splits is still there, except now there is the advantage that it is permeable from space between the ion exchange material where solvent 300 may flow through it.

The function of the resin between the AEL 230, 430 and CEL 220, 420 is to allow for solvent 300 flow during the RBPED process. At the same time an interface between anion exchange polymer and cation exchange polymer is may be maintained so that the solvent splitting reaction may occur. As the acid and base react to form the solvent at the BPM interface 260, the solvent 300 may accumulate. IEMs may have a low permeability to solvent so if the rate of solvent accumulation is greater than the rate of pressure driven flow, the BPM 200, 400 may delaminate due to excess pressure build up in the BPM interface 260. The resin allows a path for the solvent 300 to flow to prevent the excess pressure build up. The solvent may flow back out through the AEL 230, 430 and/or CEL 220, 420, (perpendicular to the membrane surface), or it may flow through the resin (parallel to the membrane surface). If the solvent flows through the resin, there may or may not be an outlet to the SPL 418 for the solvent 300 to flow. It may also flow into the acid, base, salt, electrode outlet 148, 158, 168, 113, 115. There may or may not be patterns in the resin in the BPM interface 260 or SPL 410 to enhance the solvent permeability in any given direction. Examples of patterns in the resin may be channels in one direction in rectangular, circular or triangular shape among others. Binder may be used to help make the channels.

The resin may also enhance the ionic conductivity of the BPM 200, 400, thereby reducing resistive losses and increasing the power obtained during RBPED or decreasing the power loss for FBPED. For a simple BPM 200, during RBPED the solvent 300 that accumulates in the BPM interface 260, may create a resistive layer if the solvent has a low concentration of solute. The resin allows ion percolation through its structure, reducing the chance of this resistive layer to form.

The resin may be catalyzed to promote the solvent splitting.

The resin may have a particle size distribution. The advantage of having smaller particles is that there is more surface area for the interface between cation exchange polymer and cation exchange polymer, promoting solvent splitting for FBPED. The advantage of having larger resin particles is that there will be a greater void space between the particles for solvent to flow.

Solvent flow may be perpendicular to the electric field during forward or reverse process. This may be advantageous for reducing the pressure generated from the solvent formation at the BPM interface. Solution from the acid stream 140 or the base stream 150, or another solution 419 may flow through the resin layer. This may be used to control if the SPL 410 is acidic or basic. By doing this the location of the reaction interface may be controlled depending on acidic or basic solution flows through the SPL 410 or AER 412, 413 and/or CER 414, 415 that is adjacent to an AEL 430, 230 or CEL 420, 220 (with option for catalyst layer to be in between any permutation of interfaces listed). Controlling the location of the BPM interface with an external flow may be more useful if the SPL 410 is made of MBR 416, where a mixed bed of resin may cause for an inhomogeneous BPM interface 260.

In various embodiments, ion exchange resin (AER/CER/MBR) may be replaced by any suitable kind of ion exchange material.

In view of the above, conductivity of BPM interface may be improved through use of ion exchange polymer such as IER, among other alternatives (compared to the case where solvent accumulates at the BPM interface) for RBPED and/or FBPED operation.

IER may be used to create a layer where solvent will split/dissociate during FBPED and/or a BPED flow battery.

IER may be used to create a layer where ion conduction and/or surface area is sufficient for FBPED and/or RBPED reactions may take place.

IER may be used to create a layer where solvent will flow within a BPM for FBPED and/or RBPED and/or BPED flow batteries.

A catalyst, which may include iron-based catalysts and/or aluminum-based catalysts, among other alternatives, may be applied to the IER to split solvent in a BPM for a BPED flow battery and/or FBPED.

A catalyst, which may include iron-based catalysts and/or aluminum-based catalysts, among other alternatives, may be applied to the IER to split solvent in a BPM into an acid and it's conjugate base for a BPED flow battery and/or FBPED system.

A catalyst, which may include iron-based catalysts and/or aluminum-based catalysts, among other alternatives, may be applied to the IER in between the AEL and CEL of a BPM to split/dissociate water into H⁺ and OH⁻ for FBPED and/or BPED flow batteries.

A catalyst, which may include iron-based catalysts and/or aluminum-based catalysts, among other alternatives, may be applied to split/dissociate methanol into its acid and conjugate base for FBPED and/or BPED flow batteries in the SPL and/or BPM.

A catalyst, which may include iron-based catalysts and/or aluminum-based catalysts, among other alternatives, may be applied to the IER in between the AEL and CEL of a BPM to split/dissociate methanol into H⁺ and CH₃O⁻ for FBPED and/or BPED flow batteries.

A catalyst, which may include iron-based catalysts and/or aluminum-based catalysts, among other alternatives, may be applied to a BPM interface and/or SPL with or without combination with high surface area ion exchange polymer like IER to enhance the kinetics/equilibrium properties of solvent splitting/dissociation at any range of temperatures, including low temperature operations for FBPED and/or BPED flow batteries.

The combination of high surface area of the IER and a catalyst, which may include iron-based catalysts and/or aluminum-based catalysts, among other alternatives, may be used to enhance the splitting/dissociation of the solvent reaction in a BPM/BPM interface/SPL for FBPED while maintaining solvent permeability for RBPED processes.

A size distribution of resin/ion exchange particles/ion exchange resin may be used in a BPM/SPL/BPM interface to have high surface area at smaller resin particles where solvent will split for FBPED and/or BPED flow batteries, that is in contact with resin particles of larger surface area to maintain ionic conduction for FBPED and/or RBPED and/or BPED flow batteries, as well as allow for solvent flow between resin particles for RBPED and/or BPED flow batteries.

Fine IER may be used anywhere within/distributed through a SPL of coarser IER to improve ionic conductivity for FBPED and/or RBPED and/or BPED flow batteries.

Mixed bed resin (CER and AER) may be used in any heterogenous/homogeneous mixture in any ratio of

AER to CER and/or any ratio of resin size for RBPED and/or FBPED and/or BPED flow batteries. A layer may be provided in between the AEL and CEL of a BPM that is connected to a reservoir (i.e., through a manifold, similar to the flow streams) where flow may occur through the solvent permeation layer and properties of the liquid flowing through the SPL may be used to control the composition, concentration, pH, etc of the solvent permeation layer for FBPED and/or RBPED and/or BPED flow batteries.

A system may include resin that is patterned in a BPM/SPL for FBPED and/or RBPED and/or BPED flow batteries.

A system may include resin that is patterned in a BPM/SPL to control solvent flow through the resin bed for FBPED and/or RBPED and/or BPED flow batteries.

A system may include resin that is patterned in a BPM/SPL using the polymer binder to fix the resin in place for FBPED and/or RBPED and/or SPED flow batteries. The placement of IER between ion exchange membranes and/or between the AEL and CEL of a BPM and/or in the SPL allows for conduction of ions such as products of a solvent dissociation reaction, or other ions through the IER and/or the fluid around the IER and solvent flow in the space between resin particles for FBPED and/or RBPED and/or BPED flow batteries, wherein:
A layer of anion exchange resin is in between the AEL and CEL of a BPM for FBPED and/or RBPED and/or BPED flow batteries;
A layer of cation exchange resin is in between the AEL and CEL of a BPM for FBPED and/or RBPED and/or BPED flow batteries;
A layer of mixed cation and anion exchange resin is between the AEL and CEL of a BPM for FBPED and/or RBPED and/or BPED flow batteries;
There is fine anion exchange resin adjacent to the CEL on one side and coarse anion exchange resin on the other side with the bipolar junction/BPM interface between the fine anion resin and the CEL;
There is fine cation exchange resin adjacent to the AEL on one side and coarse cation exchange resin on the other side with the bipolar junction/BPM interface between the fine cation resin and the AEL;
There is anion exchange resin in contact with the AEL on one side of the AER and cation exchange resin on the other side of the AER, and the other side of the CER is in contact with a CEL, with the bipolar junction/BPM interface being between the anion exchange resin and cation exchange resin wherein:
   There may be fine anion exchange resin on either or both sides of coarse AER resin and/or fine cation exchange resin on either or both sides of coarse cation exchange resin;
For any system as described above where the anion exchange resin and/or cation exchange resin is coated with catalyst which may include iron based catalysts and/or aluminum based catalysts, among other alternatives, to facilitate solvent dissociation in a BPM;
For any system as described above where the fine ion exchange resin is obtained from crushed coarse ion exchange resin;
The ion exchange resin may be replaced with inert material such as glass beads or any ion conducting or non-conducting material which may have a purpose of allowing solvent flow in the SPL;
For any system as described above where there is a particle size distribution of ion exchange resin particles and/or ion exchange material and/or inert material in a SPL/BPM ranging from 10 mm-10 nm;
A system where the ion exchange resin and/or ion exchange material and/or inert material in a SPL/BPM is bound by a polymer binder wherein the polymer binder may be conductive and/or non-conductive to ions;
The ion exchange resin and/or ion exchange material and/or inert material is patterned to promote certain transport properties such as solvent flow, ion flow, and/or heat, among others;
The ion exchange resin and/or ion exchange material and/or inert material is patterned to control water flow through the resin bed; and/or
The ion exchange resin and/or ion exchange material and/or inert material is patterned using the polymer binder to fix it in place.

A BPM where IER may replace the CEL and/or AEL in a BPM to have a permeable layer for solvent to flow through during RBPED and/or BPED flow batteries.

A BPM where IER may be held together with binder replaces the CEL and/or AEL in a BPM to have a permeable layer for solvent to flow through during RBPED and/or BPED flow batteries. A BPM with IER in between the AEL and/or CEL where there is no flow through the SPL for FBPED and/or RBPED and/or BPED flow batteries.

A BPM with IER in between the AEL and/or CEL where there may be flow through the SPL for FBPED and/or RBPED and/or BPED flow batteries.

### Permeable BPM Embodiment

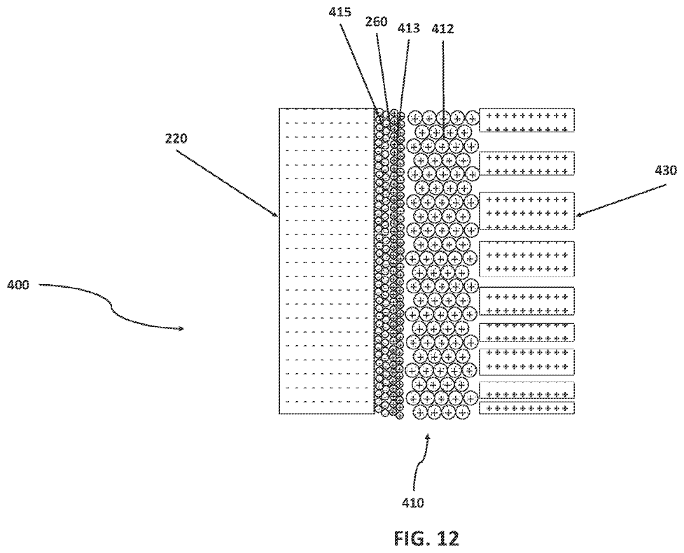

Referring to FIG. 12, an example of a preferred embodiment of the permeable BPM 400 is described in more detail. This embodiment captures the benefits of effective permeability for solvent flow and effective FBPED operation. The CEL 220 is a less permeable layer. The SPL 410 is composed of AER 412 with fine AER 413 at the anion exchange side of the BPM interface 260. Fine CER 415 is in contact with the CEL 220 and the cation exchange side of the BPM interface 260. The fine resin 413 and 415 in the SPL 410 is catalyzed with catalyst 264 that enhances the splitting of water and methanol. The permeable AEL 430 is in contact with the AER 412. The permeable AEL 430 is more permeable at higher concentration of any given solute. For RBPED operation the higher concentration solute is in the acid stream and due to the RBPED process there is a concentration gradient of high to low from the inlet to the outlet. This causes the permeable AEL 430 to be more permeable at the inlet than the outlet. The SPL 410 has a pattern to promote solvent 300 flow toward the inlet. During FBPED operation the impermeable CEL 220 maintains permselectivity to lessen effects of contamination and may enable effective solvent splitting. The BPM interface between the fine AER 413 and fine CER 415 paired with the catalyst 264 causes a high surface area catalyzed BPM interface 260 that enables splitting of a solvent mixture, such as water and methanol at any suitable temperature, including well below 0 degrees Celsius. During RBPED operation, the solvent 300 may be generated in the BPM interface 260 of fine AER 413 and fine CER 415. Since the fine resins 413, 415 are directly adjacent to the AER 412, the solvent 300 may flow to the void between AER 412 resin particles. From the AER 412 the solvent 300 may flow out of the SPL 410 through an external manifold, or through the permeable AEL 430. In this embodiment, several other permutations are possible, including swapping anion exchange polymer for cation exchange polymer in all of the resin/ion exchange layers mentioned, to achieve a similar effect.

In conjunction with a permeable membrane, a patterned SPL may be used to direct solvent flow towards a region where the AEL and/or CEL is more permeable to through-membrane flow such as the inlet and/or outlet regions of the SPL and/or BPM and/or cell triplet.

The operation of a BPED flow battery with a BPM that may be comprised of an impermeable CEL and a permeable AEL or vice versa that increases permeability with increasing concentration of solution Within the BPED flow battery, a concentration gradient may be applied for RBPED operation to have a stronger concentration at the inlet of the acid/base streams than the outlet, which may make the membranes more permeable near the inlet. The solvent formed in the SPL may flow towards the areas of higher permeability near the inlet, and out the AEL or CEL due to pressure driven solvent flow in the BPM during RBPED. During FBPED, lower concentration gradients may be used so the AEL or CEL of the BPM may be less permeable and more selective for more effective during FBPED operation wherein:
the SPL may have a patterned flow path;
the SPL may not be present
the SPL may be comprised of IER;
the SPL may be composed of inert materials and/or ion conducting materials to allow solvent flow.

### Integrated Heat Exchange

During the RBPED process, upon the formation of solvent at the BPM interface, heat may be generated from the formation chemical reaction. Heat may also be generated from ohmic losses of ions flowing through the solution and membranes during both RBPED and FBPED. This heat is considered a loss in terms of the voltage efficiency. The heat may be recovered and exchanged outside the system, for the purpose of heating something else up, for example, for an application of combined heat and power, among other examples, or maintaining the system within a given temperature range. The cell triplet 101 may be treated like a heat exchanger, where heat may be exchanged between any of the following streams: acid Stream 140, base Stream 150, salt Stream 160, SPL stream 419. The heat exchange may apply to the SPL 400, the acid stream 140, base stream, 150 or salt stream 160. With the BPED stack 100 uses as a heat source, any streams flowing through it may be heated up. All streams may accumulate heat from ohmic losses. During RBPED operation, heat is generated in the BPM 200, 400, so the acid stream 140 and base stream 150 may accumulate more heat than the salt stream 160. The stream flowing through the SPL 419 may accumulate heat directly as the exothermic reaction would take place in between the AEL 220, 240 and CEL 230, 250, where the SPL 410 is. The AEL 220, 240 and/or CEL 230, 250 may be designed with a lower thermal conductivity to promote the heat accumulation to the SPL stream 419 if both are insulated, and/or the acid stream 140 and/or base stream 150 if one is insulated. Thermal energy may be built up in tanks and then in contact with a separate heat exchanger, directly in the stack.

For embodiments involving heat exchange between the SPL stream 419, the SPL may include material with good heat transfer properties. The resin may have a high thermal conductivity by having a high catalyst loading of iron, aluminum or other metal-based catalysts. The benefit of this may be fast dissipation of heat to the acid stream 140 and/or base stream 150 and/or SPL stream 419. The SPL stream 419 may have a sufficiently fast flow rate to prevent accumulation of heat in the BPM interface 260. If too much heat accumulates during the RBPED and/or FBPED process, the BPM 200, 400 may be damaged from the heat. Some membranes have maximum operating temperatures as low as 40 degrees Celsius to 60 degrees Celsius. A colder fluid may be used to flow through the SPL 419 to keep the operating temperature low and prevent membrane damage. At the same time, this SPL fluid 419 may be used as a heat exchange fluid after accumulating heat through the SPL 410, and may then exchange heat with other processes. Examples of where this would be useful may be for combined heat and power operations, or for use in heating components in buildings.

The SPL may be patterned to improve the heat transfer properties. For example, in an embodiment with resin in the SPL. it may be applied with binder to create a serpentine flow path through the SPL. This would lengthen the flow path through the SPL to improve the heat transfer properties. Other ways of increasing the flow path may be implemented.

Alternatively, the AEL and CEL may serve as insulators to keep the high temperature loss localized to the SPL. This would be favorable for embodiments heat is exchanged from the SPL stream with the SPL stream heating up another entity. An example of this may be a refrigerant or process water in an external heat exchanger.

In view of the above, a BPED flow battery and/or FBPED and/or RBPED that may use generated heat from inefficiencies of ohmic ion transport and/or from the solvent formation reaction as a heat source for other processes may:
include storage tanks for the acid, base, salt and/or SPL reservoir to accumulate heat and transfer heat to coils in the tanks;
include solutions in the storage tanks to be pumped through external heat exchangers;
include cell triplets in the BPED flow battery and/or FBPED and/or RBPED that may be used as a heat exchanger;
maintain operating temperature below a certain temperature via heat exchange with other processes; and/or
include tanks kept at different temperatures so that the streams are exchanging heat with each other, one or more of the tanks are heating an external process fluid and/or one of the tanks (preferably the acid stream storage tank) is kept at a lower temperature to reduce the acidic cation and/or basic anion diffusion coefficient.

A cell triplet in the BPED flow battery and/or FBPED and/or RBPED may also serve as an integrated heat exchanger. Heat may be exchanged between any of the streams flowing through the cell triplet, including the acid stream, base stream, salt stream and/or stream flowing through the SPL, in which:
storage tanks for the acid, base, salt and/or SPL reservoir may be used to accumulate heat and transfer heat to coils in the tanks;
solutions in the storage tanks may be pumped through external heat exchangers;
cell triplets in the BPED flow battery and/or FBPED and/or RBPED may be used as a heat exchanger;
an operating temperature may be maintained below a certain temperature via heat exchange with other processes;
tanks may be kept at different temperatures so that the streams are exchanging heat with each other, one or more of the tanks are heating an external process fluid and/or one of the tanks (preferably the acid stream storage tank) is kept at a lower temperature to reduce the acidic cation and/or basic anion diffusion coefficient; and/or
a patterned SPL may be positioned in between the AEL and CEL of a BPM for a BPED flow battery and/or FBPED and/or RBPED, wherein there may be an elongated flow path through the SPL such as a serpentine flow path among other examples to improve the heat transfer properties to/from a stream that flows through the SPL.

An AEL and/or CEL of a BPM may have a low thermal conductivity for a BPED flow battery and/or FBPED and/or RBPED in which:
The AEL may be insulated to promote heat transfer and/or heat generated from the solvent formation reaction to the acid stream;
The CEL may be insulated to promote heat transfer and/or heat generated from the solvent formation reaction to the base stream; and/or
Both the AEL and CEL may be insulated to keep heat in the stream flowing through the SPL.

### Ion Exchange Column

The ion exchange column (IEC) 500 is a container or vessel 502 with ion exchange material 510 inside, such as IER (e.g., AER 520, CER 540). The IEC 500 has an inlet 504 and outlet 506 for fluid to enter and leave. The ion exchange material 510 is to exchange ions with streams that flow through it to change the composition/concentration of the streams.

The IEC 500 is used to regenerate the streams after operating with membranes 200, 400, 120, 130 with non-perfect permselectivity. With a low permselectivity, ions that are not desired may cross the IEMs, causing contamination of the acid stream 140, salt stream 160, base stream 150 and/or electrode streams 118, 119. These streams may change in composition and concentration over continued operation. One example is the salt stream 160 getting contaminated with acid due to acidic cations 144 crossing the AEM 130 from the acid stream 140. Different embodiments of the IEMs and/or BPM 200, 400 may involve a lower permselectivity to improve other properties such as permeability. This means that the streams will be contaminated faster. The high diffusivity of H⁺ and OH⁻ may also lead to contamination of streams through a self-discharge process, where the ions will diffuse across the AEM 130 or CEM 120, contaminating the adjacent stream.

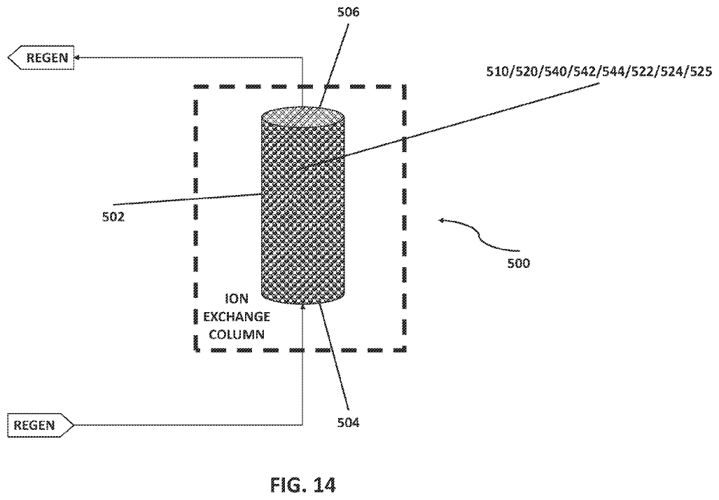

FIGS. 13 and 14 shows an example of an IEC 500 paired with BPED operation. The salt stream 160 may accumulate acidic cations 144 (H⁺ for example) over continued operation. During a regeneration process, the salt stream 160 may flow through the IEC 500, which may be filled with CER 540 in the salt cation 165 form—542 (Na⁺ form if the salt is NaCl for example). The acidic cations 144 will be exchanged for salt cations 165, removing the acidity from the salt stream 160, putting it back to its desired concentration. It may also flow through AER 520 in basic anion 154 form—524. The acidic cation 144 in the salt stream 160 will react with the basic anion 154 (OH⁻ or CH₃O⁻ are examples), neutralizing the acid. The salt anion 164 (or acid anion), such as Cl if HCl/NaCl are used, from the acid will take the place of the basic anion 154 in the AER 520 to make AER in the salt anion form 522. This is another way to neutralize the acid in the salt stream 160: by changing the overall concentration of the total stream.

Similar embodiments exist for eliminating basic anions 154 in the salt stream 160, or for removing unwanted salt anions 164 or salt cations 165 in the acid, base, or salt streams 140, 150, 160. For the regeneration process, once a stream has been purified back to its desired concentrations, the other streams may be replenished in their concentrations by charging or discharging the BPED system 100. Solvent or solute may be added or removed externally during the regeneration process. The regeneration process may operate simultaneously to the FBPED and/or the RBPED process with monitoring of concentrations to trigger stream separation 580 to the regeneration section of the process. The stream separation 580 may be in the form of valves, or any other reasonable way to separate and/or isolate flow streams. The regeneration may also be performed in a batch style process, after one or several FBPED/RBPED cycles. The regeneration process may be closed or open loop.

This describes the regeneration streams in more detail. Any of the streams may be regenerated at any point during the FBPED or RBPED process. Preferred embodiments involve using less transfer of ions to the IEC 500. For example, regeneration of the salt stream 160 may occur after or before FBPED. It may flow through CER in salt cation form 542 to replace the acidic cation 144 (for example H⁺) in the salt stream with the salt cation 165 (for example Na⁺). In a preferred embodiment, regeneration for the acid may take place after RBPED. If contaminated with salt cation 165, it may flow through CER 540 in the acid cation 144 form—544 to replace the salt cation (Na⁺ for example) with acidic cation (H⁺ for example). In another embodiment, the stream may flow through MBR 530 to remove all solute and then the solute may be added back to the preferred composition/concentration.

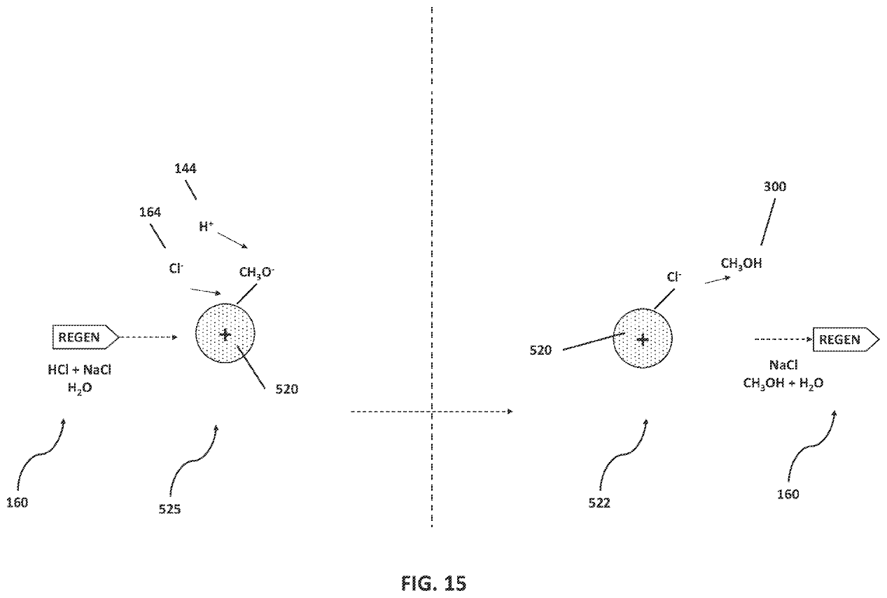

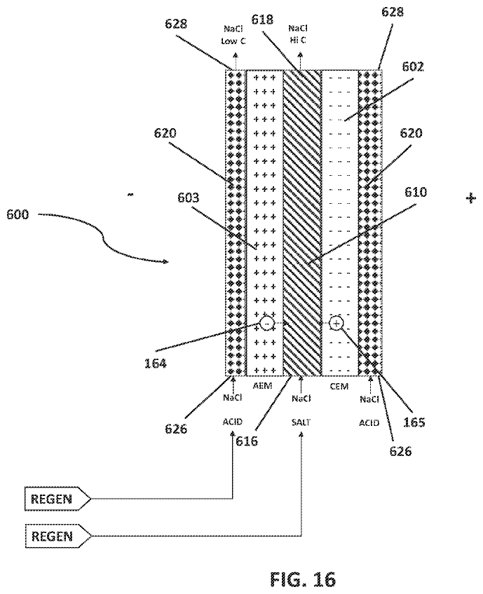

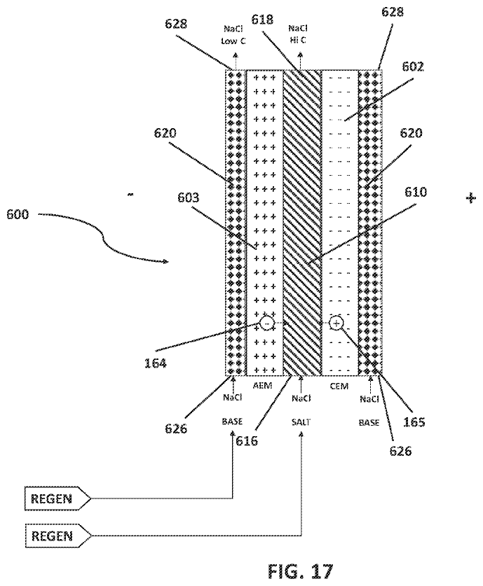

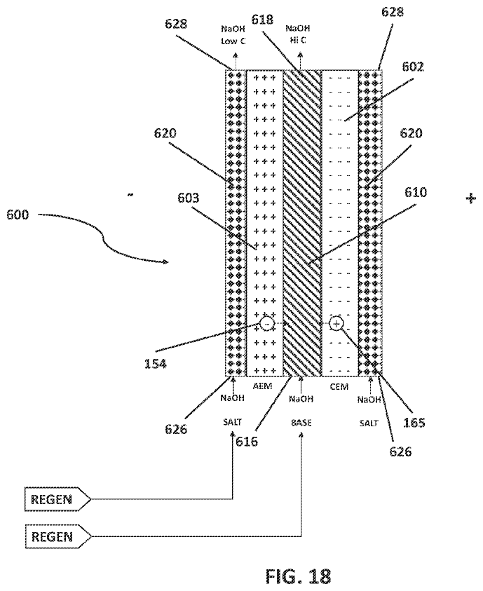

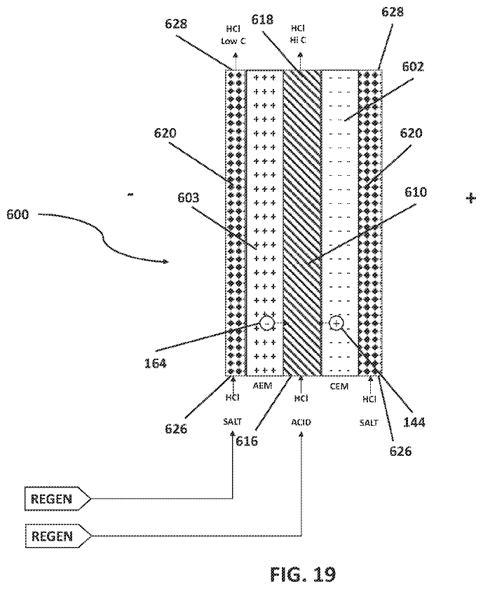

Solvent recovery processes are also possible. For the example of water solvents, if the AER 520 and/or CER 540 in the IEC 500 is in basic or acidic form (524 or 544), water may form if a basic or acidic solution, respectively, flows through the IEC 500. For example if the salt stream 160 contaminated with acid HCl flows through AER in the basic anion form 524 (OH⁻ form), Cl⁻ will exchange with the OH⁻, putting the resin in Cl form, and the H⁺ reacts with the OH⁻ to form H₂O. This H₂O is added to the stream in the process. In this example, while regenerating the salt stream 160, solvent 300 is being added. In a similar way, for non-water solvents, the IEC 500 may be preloaded with the conjugate base or acid of any solvent material. This process may be used to control the amount of solvent in any of the streams. For systems with solvent mixtures, the IEC 500 may be loaded with any mixture of conjugate acid, base, or solute (in any form) to control the amount of solute and solvent in the streams (both composition and concentration). In the example of a methanol/water solvent mixture, the IEC may be preloaded with AER in CH₃O⁻ form. For example if a salt stream 160 of NaCl dissolved in a H₂O and CH₃OH mixture, contaminated with HCl, flows through AER in the CH₃O⁻ form 525, the Cl would exchange with the CH₃O⁻, and the CH₃O⁻ would react with H⁺ to form the solvent CH₃OH, as shown in FIG. 15. The same mixture may flow through AER 520 in OH⁻ form to add H₂O solvent to the stream. Depending on the ratio of solvents split (i.e., water to methanol), it may be desirable to replenish solvent in various amounts, and an IEC 500 may be loaded with AER 520 with any ratio of resin in any form, for example in a ratio of AER in CH₃O⁻ form to OH⁻ form. In a similar way CER may be used to regenerate solvents for streams of basic composition. The same may apply for multi component systems for solvent and/or solute. It should be apparent that this may be applied for any combination of solute, solvent, conjugate acid, conjugate base, and/or form of AER and/or CER, or any mixture of AER/CER.

### Electrodialysis (ED) Stack

The electrodialysis (ED) cell 600 is a stack of alternating AEMs 603 and CEMs 602 with flow streams in between. lons cross the ion exchange membranes in an electric field. The AEM 603 may be selective for certain ions such as basic anions 154 or salt anions 164, and the CEM 602 may be selective for certain ions such as acidic cations 144 or salt cations 165 to aid in the regeneration process. Electrodes similar to the electrodes in the BPED system may apply the electric current/electric field. There are streams in between the membranes that get concentrated with ions (the concentrate stream 610) and streams that get depleted of ions (the dilute stream 620). The regeneration stream 580 (which may come from either the acid stream 140, base stream 150 and/or salt stream 160) may be sent to the inlet of the concentrate stream 626 and/or the inlet of the dilute stream 616. The stream flowing out of the dilute stream outlet 628 may then be sent back to the BPED flow battery regeneration stream 580 from which it was drawn. The stream flowing out of the concentrate stream outlet 618 may then be sent back to the BPED flow battery regeneration stream 580 from which it was drawn.

Another example of a solvent regeneration process may be to pair an electrodialysis (ED) cell(s) 600 with a BPED flow battery. This may be an alternative to an ion exchange column 500 for a solvent regeneration process. The ED cell 600 may be used to regenerate BPED streams, moving ions that have accumulated from undesired ion transport to different streams. In a preferred embodiment, the ions may be directly transferred between acid and/or base and/or salt streams in the BPED flow battery.

One way to use ED for solvent regeneration may be to remove salt cations 165 and/or salt anions 164 that have contaminated the acid stream 140 and/or base stream 150. In the example of a system with the acid stream 140, base stream 150 and salt stream 160 as HCl, NaOH, and NaCl, respectively, the acid stream 140 and/or base stream 150 may have excess salt ions NaCl. One way to remove this excess NaCl would be to do so when the BPED flow battery is in a discharged state. If the BPED flow battery is in a discharged state, the concentrations of acid (HCl) and base (NaOH) in their respective streams would be small (with the salt stream 160 having a high concentration of salt ions 164, 165), but the salt cations 165 and salt anions 164 that contaminated the acid stream 140 and/or base stream 150 (from the salt stream 160) may be present in these streams. The acid stream 140 and/or base stream 150 may then be sent to an ED cell 600 as the dilute stream 620 to regenerate the streams by transferring the salt ions out, through the AEM 603 and CEM 602 to the concentrate stream 610. The removed salt ions 164/165 (transferred from the dilute stream 620 to concentrate stream 610 in ED cell 600) may then be added back to the salt stream 160 and/or regeneration stream 580. In a preferred embodiment, the concentrate stream 610 may be the salt stream 160 from the BPED flow battery to directly transfer the ions from the acid stream 140 and/or base stream 150 to the salt stream 160. In another embodiment, the ions may be transferred indirectly as well, by using another stream to collect the salt ions 164/165 which may then get transferred back to the salt stream 160. Membranes that are selective to salt ions 164/165 may be used to help facilitate the desired transport of salt ions 164/165 over acidic cations 144 and/or basic anions 154.

Another regeneration process may be to use the ED cell 600 to regenerate the salt stream 160 if it has been contaminated with acidic cations 144 and/or basic anions 154. The regeneration may take place when the BPED flow battery is in a charged state. In this scenario, the salt stream 160 may have a small concentration of the salt ions 164, 165 (with the acid stream 140 and base stream 150 having a high concentration of acidic cations 144 and/or basic anions 154), and acidic cations 144 or basic anions 154 present that have accumulated in the salt stream 160 from the acid stream 140 or base stream 150 over operation of the BPED flow battery with imperfectly selective membranes. The salt stream 160 may be sent to the ED cell 600 as the dilute stream 620 to transfer the acidic cations 144 or basic anions 154 across the AEM 603 and/or CEM 602 to the concentrate stream 610 which may be then transferred back (directly or indirectly) to the acid stream 140 or base stream 150. In a preferred embodiment, the concentrate stream 610 may be from the acid stream 140 or base stream 150 from the BPED flow battery (may be from the regeneration stream 580) to directly transfer the acidic cations 144 or basic anions 154 from the salt stream 160 to the acid stream 140 or base stream 150. In another embodiment, the ions may be transferred indirectly as well, by using another stream to collect the acidic cations 144 or basic anions 154 which may then get transferred back to the acid stream 140 or base stream 150. Membranes that are selective to acidic cations 144 (such as Nafion™ or similar) and/or basic anions 154 may be used to help facilitate the desired transport of acidic cations 144 or basic anions 154 over the transport of salt ions 165, 166.

While it has been suggested to operate in a charged and/or discharged state for preferred embodiments, this regeneration process may occur at any state of charge. If selective membranes for certain ions are used, the state of charge is less relevant.

One application for the regeneration system (IEC 500 and/or ED Cell 600) may be in the case of ‘manually’ charging the BPED Flow Battery through the addition of concentrated acid (e.g., ions 144, 164) or concentrated base (e.g., ions 154, 165) to the acid stream 140 and/or base stream 150. Doing so may increase the concentration of the acid stream 140 and base stream 150 and prolong the time that the BPED flow battery may discharge. This, however, may add an excess of ions to the system, and in discharging the battery, the salt stream 160 may accumulate more salt ions 164, 165 than before the addition of concentrated acid or base. To remove these excess salt ions 164, 165, a regeneration system may be used.

In the case of the ion exchange column 500, salt ions 164, 165 may be removed from the salt stream 160 by allowing the stream to flow through MBR 530, where the AER 520 is in basic anion form 524 and the CER 540 is in acidic cation form 544, to exchange the salt cations 165 with acidic cations 144 and salt anions 164 with basic anions 154, thereby reducing the salt ion concentration to a desired level. It is noted that the concentrations of the acid stream 140 and base stream 150 may also be reduced by flowing through AER in the basic anion form 524, and CER in the acidic cation form 544, respectively, but this would be a less preferred embodiment as it is beneficial to discharge the acid stream 140 and base stream 150 in the BPED Flow battery to reduce their concentrations.

In the case of the ED cell 600, the salt ions 164, 165 may be removed from the salt stream 160 by allowing the salt stream 160 to flow through an ED cell 600 as the dilute stream 620 to reduce the salt ion concentration by transferring the salt ions 164, 165 out, through the AEM 603 and CEM 602 to the concentrate stream 610. The removed salt ions 164, 165 (transferred from the dilute stream 620 to concentrate stream 610 in ED cell 600) may then be collected and would exit the BPED Flow battery system. The concentrate stream 610 may also be fed from the salt stream 160, or from an external solution to capture the salt ions 164/165.

In view of the above, an ion exchange column may be used in conjunction with a BPED flow battery and/or FBPED and/or RBPED.

An ion exchange column may be used in conjunction with a SPED flow battery and/or FBPED and/or RBPED to change the concentration of the streams which may include the acid and/or base and/or salt and/or electrode and/or stream flowing through the SPL.

An ion exchange column may be used in conjunction with a BPED flow battery and/or FBPED and/or RBPED to change the solvent ratio and/or concentration and/or ionic composition of the streams, in which:
The ion exchange column may be loaded with AER in the conjugate base form;
The ion exchange column may be loaded with AER in the conjugate base form to regenerate solvent and/or solute in a BPED flow battery and/or FBPED and/or RBPED;
The ion exchange column may be loaded with CER in the conjugate acid form;
The ion exchange column may be loaded with CER in the conjugate acid form to regenerate solvent and/or solute in a BPED flow battery and/or FBPED and/or RBPED;
The ion exchange column may be loaded with CER in the salt form;
The ion exchange column may be loaded with CER in the sait form regenerate solute in a BPED flow battery and/or FBPED and/or RBPED;
The ion exchange column may be loaded with AER in the salt form; and/or
The ion exchange column may be loaded with AER in the salt form regenerate solute in a BPED flow battery and/or FBPED and/or RBPED.

An ion exchange column may be loaded with ion exchange polymer containing CH₃O⁻ to regenerate methanol solvent upon reaction with H⁺ to form methanol.

An ion exchange column may be loaded with ion exchange polymer containing CH₃O⁻ to regenerate methanol solvent in a BPED flow battery.

An ion exchange column may be loaded with anion exchange polymer in the CH₃O⁻ form to regenerate methanol solvent in a BPED flow battery.

An ion exchange column may be loaded with cation or anion exchange polymer in the form of a conjugate acid or base of a solvent that may regenerate a stream for a flow battery system by adding solvent/reacting with the polymer to form solvent.

An ion exchange column may be continuously operated to change the concentrations or compositions of streams for BPED flow batteries and/or FBPED and/or RBPED (and/or flow batteries in general).

An ion exchange column may be batch operated to change the concentrations or compositions of streams for BPED flow battery and/or FBPED and/or RBPED (and/or flow batteries in general).

An ion exchange column may be used to change the concentrations or compositions of streams to add solvent to the streams for BPED flow battery and/or FBPED and/or RBPED.

An ion exchange column may be used to change the concentrations or compositions of streams to add or remove solute from the streams BPED flow battery and/or FBPED and/or RBPED.

An ion exchange column may be used to change the concentrations or compositions of streams to exchange solute from the streams to increase or decrease concentrations of the streams with the goal of rebalancing/restoring the preferred concentrations for BPED flow battery and/or FBPED and/or RBPED and/or general flow battery operation.

An electrodialysis cell(s) may be used with or without selective IEMs to regenerate concentrations of streams in a BPED flow battery.

An ion exchange column may include material that exchanges ions that may include ion exchange resin and/or ion exchange polymer.

Thus it may be seen a permeable structure for membranes where fluid may flow out through manifolds connected to a resin bed or out through a permeable membrane that changes permeability under different process conditions like solution concentration, and to make up for losses from permeable membranes (back diffusion, concentration contamination), the solutions may be regenerated with an ion exchange column. Heat may be exchanged with this system, and it may serve as a heat source and/or combined heat and power.

Regarding use of “or” in this disclosure including the claims, the term “or” is intended to be inclusive and may be read as “and/or” unless otherwise indicated. For example, phrasing such as “A, B, or C” is intended to mean A; B; C; A and B; A and C; B and C; or A, B, and C. In other words, the term “or” is used interchangeable with “and/or.”

Regarding the use of “a” disclosure including the claims, the term “a” is intended to mean one or more and not only one. That is, “a” designates one or a plurality.

The above-described embodiments of the invention are intended to be examples of the present invention and alterations and modifications may be effected thereto, by those of skill in the art, without departing from the scope of the invention.

1. A bipolar electrodialysis flow battery comprising:
a stack of cells, each cell comprising:
an acid compartment to contain flow of an acid solution;
a base compartment to contain flow of a base solution; and
a bipolar membrane disposed between the acid compartment and the base compartment;
a salt compartment to contain flow of a salt solution, the salt compartment separated from the acid compartment by an anion exchange membrane or separated from the base compartment by a cation exchange membrane;
wherein one or more of the acid compartment, base compartment, and salt compartment contain a solvent having a dielectric constant that is lower than a dielectric constant of water;
electrodes positioned at opposite ends of the stack of cells.

2. The bipolar electrodialysis flow battery of claim 1, wherein two or more of the acid compartment, base compartment, and salt compartment contain a solvent having a dielectric constant that is lower than a dielectric constant of water.

3. The bipolar electrodialysis flow battery of claim 1, wherein each of the acid compartment, base compartment, and salt compartment contains a solvent having a dielectric constant that is lower than a dielectric constant of water.

4. The bipolar electrodialysis flow battery of claim 1, wherein the dielectric constant of the solvent is between about 15 and about 80.

5. The bipolar electrodialysis flow battery of claim 1, wherein the dielectric constant of the solvent is between about 60 and about 80.

6. The bipolar electrodialysis flow battery of claim 1, wherein the solvent comprises a mixture of water and a non-water solvent.

7. The bipolar electrodialysis flow battery of claim 1, wherein the solvent comprises a mixture of two or more non-water solvents.

8. The bipolar electrodialysis flow battery of claim 1, wherein the solvent comprises glycol.

9. The bipolar electrodialysis flow battery of claim 1, wherein the solvent comprises alcohol.

10. The bipolar electrodialysis flow battery of claim 1, wherein the solvent comprises one or more of acetone, acetic acid, acetonitrile, ammonia, butanol, ethanol, glycol, ethylene glycol, formic acid, furfural, glycerol, glycerine, isopropanol, methanol, tetrahydrofuran, propanol, propylene glycol, xylitol, polyol, and an alcohol.

11. The bipolar electrodialysis flow battery of claim 1, further comprising an ion exchange column containing ion exchange material, the ion exchange column connected to one of the acid compartment, the base compartment, or the salt compartment to receive flow of a respective one of the acid solution, the base solution, or the salt solution to cause the ion exchange material to restore a concentration of ions in the respective one of the acid solution, the base solution, or the salt solution.

12. The bipolar electrodialysis flow battery of claim 1, further comprising an electrodialysis system including a cation exchange membrane and an anion exchange membrane with flow channels therebetween, wherein the flow channels are connected to two of the acid compartment, the base compartment, or the salt compartment to receive flow of respective two of the acid solution, the base solution, or the salt solution to transfer ions across the cation exchange membrane and the anion exchange membrane to remove unwanted contaminants or restore a concentration of ions in the respective two of the acid solution, the base solution, or the salt solution.

13. The bipolar electrodialysis flow battery of claim 1, further comprising:
a heat exchanger operable with the acid solution, the base solution, or the salt solution, the heat exchanger configured to:
extract heat from the solution, wherein the heat is generated by an inefficiency in ohmic ion transport or from a solvent formation reaction occurring at the stack of cells; or
provide heat to the solution.

14. The bipolar electrodialysis flow battery of claim 1, wherein the bipolar membrane comprises an anion exchange layer, a cation exchange layer, and a solvent permeation layer therebetween, wherein the solvent permeation layer includes ion exchange resin, wherein the anion exchange layer, the cation exchange layer, or the solvent permeation layer are permeable to flow of the solvent.

15. The bipolar electrodialysis flow battery of claim 14, wherein acid solution, base solution, or salt solution in contact with the anion exchange layer or the cation exchange layer alters the permeability of the anion exchange layer or the cation exchange layer.

16. A bipolar electrodialysis flow battery comprising:
a stack of cells, each cell comprising:
an acid compartment to contain flow of an acid solution;
a base compartment to contain flow of a base solution; and
a bipolar membrane disposed between the acid compartment and the base compartment;
a salt compartment to contain flow of a salt solution, the salt compartment separated from the acid compartment by an anion exchange membrane or separated from the base compartment by a cation exchange membrane;
wherein one or more of the acid compartment, base compartment, and salt compartment contain a solvent that provides a diffusion coefficient of hydrogen ions or hydroxide ions that is lower than a respective diffusion coefficient of hydrogen ions or hydroxide ions in water;
electrodes positioned at opposite ends of the stack of cells.

17. The bipolar electrodialysis flow battery of claim 16, wherein two or more of the acid compartment, base compartment, and salt compartment contain a solvent that provides a diffusion coefficient of hydrogen ions or hydroxide ions that is lower than a respective diffusion coefficient of hydrogen ions or hydroxide ions in water.

18. The bipolar electrodialysis flow battery of claim 16, wherein each of the acid compartment, base compartment, and salt compartment contains a solvent that provides a diffusion coefficient of hydrogen ions or hydroxide ions that is lower than a respective diffusion coefficient of hydrogen ions or hydroxide ions in water.

19. The bipolar electrodialysis flow battery of claim 16, wherein the solvent provides a diffusion coefficient of hydrogen ions that is less than about 9.3*10⁻⁹ m²/s.

20. The bipolar electrodialysis flow battery of claim 16, wherein the solvent provides a diffusion coefficient of hydrogen ions that is between about 3*10⁻⁹ m²/s and about 9.3*10⁻⁹ m²/s.

21. The bipolar electrodialysis flow battery of claim 16, wherein the solvent provides a diffusion coefficient of hydroxide ions that is less than about 5.3*10⁻⁹ m²/s.

22. The bipolar electrodialysis flow battery of claim 16, wherein the solvent provides a diffusion coefficient of hydroxide ions that is between about 2*10⁻⁹ m²/s and about 5.3*10⁻⁹ m²/s.

23. The bipolar electrodialysis flow battery of claim 16, wherein the solvent comprises a mixture of water and a non-water solvent.

24. The bipolar electrodialysis flow battery of claim 16, wherein the solvent comprises a mixture of two or more non-water solvents.

25. The bipolar electrodialysis flow battery of claim 16, wherein the solvent comprises glycol.

26. The bipolar electrodialysis flow battery of claim 16, wherein the solvent comprises alcohol.

27. The bipolar electrodialysis flow battery of claim 16, wherein the solvent comprises one or more of acetone, acetic acid, acetonitrile, ammonia, butanol, ethanol, glycol, ethylene glycol, formic acid, furfural, glycerol, glycerine, isopropanol, methanol, tetrahydrofuran, propanol, propylene glycol, xylitol, polyol, and an alcohol.

28. The bipolar electrodialysis flow battery of claim 16, further comprising an ion exchange column containing ion exchange material, the ion exchange column connected to one of the acid compartment, the base compartment, or the salt compartment to receive flow of a respective one of the acid solution, the base solution, or the salt solution to cause the ion exchange material to restore a concentration of ions in the respective one of the acid solution, the base solution, or the salt solution.

29. The bipolar electrodialysis flow battery of claim 16, further comprising an electrodialysis system including a cation exchange membrane and an anion exchange membrane with flow channels therebetween, wherein the flow channels are connected to two of the acid compartment, the base compartment, or the salt compartment to receive flow of respective two of the acid solution, the base solution, or the salt solution to transfer ions across the cation exchange membrane and the anion exchange membrane to remove unwanted contaminants or restore a concentration of ions in the respective two of the acid solution, the base solution, or the salt solution.

30. The bipolar electrodialysis flow battery of claim 16, further comprising:
a heat exchanger operable with the acid solution, the base solution, or the salt solution, the heat exchanger configured to:
extract heat from the tank, wherein the heat is generated by an inefficiency in ohmic ion transport or from a solvent formation reaction occurring at the stack of cells; or
provide heat to the solution.

31. The bipolar electrodialysis flow battery of claim 16, wherein the bipolar membrane comprises an anion exchange layer, a cation exchange layer, and a solvent permeation layer therebetween, wherein the solvent permeation layer includes ion exchange resin, wherein the anion exchange layer, the cation exchange layer, or the solvent permeation layer are permeable to flow of the solvent.

32. The bipolar electrodialysis flow battery of claim 31, wherein acid solution, base solution, or salt solution in contact with the anion exchange layer or the cation exchange layer alters the permeability of the anion exchange layer or the cation exchange layer.
